(19) United States
(12) Patent Application Publication
(10) Pub. No.: US 2025/0303647 A1
(43) Pub. Date: Oct. 2, 2025

(54) METHOD AND APPARATUS FOR PRODUCING A CUSHION

(71) Applicant: LEAR CORPORATION, Southfield, MI (US)

(72) Inventors: Ibrahim VALENZUELA, Novi, MI (US); Haifeng LIU, Novi, MI (US); Lisa SWIKOSKI, West Bloomfield, MI (US); Kevin M. GEISLER, Menlo Park, CA (US); Michelle A. BRUDZYNSKY, Farmington Hills, MI (US); Jeanene F. MUNROE, Southfield, MI (US); Joseph A. HIMMEL, Livonia, MI (US)

(73) Assignee: LEAR CORPORATION, Southfield, MI (US)

(21) Appl. No.: 18/864,795

(22) PCT Filed: May 11, 2023
(86) PCT No.: PCT/US2023/021869

§ 371 Date: Nov. 11, 2024

Related U.S. Application Data
(63) Continuation-in-part of application No. 17/741,639, filed on May 11, 2022.
(60) Provisional application No. 63/353,728, filed on Jun. 20, 2022.
(60) Provisional application No. 63/356,526, filed on Jun. 29, 2022.
(60) Provisional application No. 63/356,539, filed on Jun. 29, 2022.
(60) Provisional application No. 63/357,163, filed on Jun. 30, 2022.
(60) Provisional application No. 63/357,222, filed on Jun. 30, 2022.

(51) Int. Cl. B29C 67/08; B29L 31/00; B29L 31/30

(52) U.S. Cl. CPC B29C 67/08; B29L 2031/3005; B29L 2031/771

(57) ABSTRACT

A method to produce a vehicular seat cushion is provided. The method may include heating a polymeric material to a molten state, dispensing the molten polymer through a die plate having a plurality of holes such that a plurality of polymeric filaments is dispensed from the die plate, and cooling the molten polymeric filaments after leaving the die plate. The die plate may include a first area having a plurality of first holes therethrough and a second area containing a plurality of second holes therethrough. The plurality of first and second holes may respectively define a first open space per unit area in the first area and a second open space per unit area in the second area. The first open space per unit area may be greater than the second open space per unit area.

### CROSS-REFERENCE TO RELATED CASES

This application is a continuation-in-part of U.S. application Ser. No. 17/741,639 filed on May 11, 2022 and claims the benefit of U.S. Provisional Patent Application No. 63/353,728 filed on Jun. 20, 2022, U.S. Provisional Patent Application No. 63/357,163 filed on Jun. 30, 2022, U.S. Provisional Application No. 63/357,222 filed on Jun. 30, 2022, U.S. Provisional Patent Application No. 63/356,539 filed on Jun. 29, 2022, and 63/356,526 filed on Jun. 29, 2022, the disclosures of which are hereby incorporated by reference in their entirety.

### TECHNICAL FIELD

The present disclosure relates to methods and apparatuses for producing interior components such as foamless cushions for seat assemblies that may be used in vehicles.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1 shows a schematic illustration of a system and method in accordance with embodiments described herein.

FIG. 2 shows a die plate usable as part of the process shown in FIG. 1.

FIG. 3 shows a die-plate arrangement in accordance with embodiments described herein.

FIG. 4 shows another die-plate arrangement in accordance with embodiments described herein.

FIG. 5 shows a cushion blank forming a part of a vehicle interior component in accordance with embodiments described herein.

FIG. 6 shows a die-plate arrangement and funnel usable as part of the method in accordance with embodiments described herein.

FIG. 7 is a front perspective view of a vehicle seat assembly according to an embodiment.

FIG. 8 is a front elevation schematic view of a system to manufacture a seat cushion of the seat assembly of FIG. 7.

FIG. 9 is a top perspective view of a tool plate of the system of FIG. 8 according to an embodiment.

FIG. 10 is a partial top perspective view of the system of FIG. 8.

FIG. 11 is a top perspective view of a tool mold of the system of FIG. 8 according to an embodiment.

FIG. 12 is a front partial perspective view of a cushion of the seat assembly of FIG. 7, according to an embodiment.

FIG. 13 is a top plan view of tooling plate of the system of FIG. 13.

FIG. 14 is a side elevation view of a plurality of strands and a plurality of films of the system of FIG. 13.

FIG. 15 is an enlarged front perspective view of the system of FIG. 13.

FIG. 16 shows a portion of the system including a heating arrangement in accordance with embodiments described herein.

FIG. 17 shows the application of a heating arrangement to a polymeric filament in accordance with embodiments described herein.

FIG. 18 shows a cross-section of a vehicle interior component manufactured in accordance with embodiments described herein.

FIG. 19 schematically illustrates a perspective view of a seat cushion or a seat back according to an embodiment.

FIG. 20 schematically illustrates a cross-sectional front view of the seat assembly of FIG. 19.

FIG. 21 schematically illustrates components used in the method of FIG. 1 according to another embodiment.

FIG. 22 is a perspective view of an embodiment of a seat assembly with a portion of the trim cover and cushion removed.

FIG. 23 is perspective view of an embodiment of a non-foam/foamless cushion.

FIG. 24 is a schematic of an embodiment of a non-foam/foamless cushion having a variable hardness/bulk density/strand size.

FIG. 25 is a schematic of another embodiment of a non-foam/foamless cushion having a hardness/bulk density/average strand size gradient.

FIG. 26 is a perspective view of an embodiment of a breaker plate for dispensing resin used to manufacture non-foam/foamless cushions.

FIG. 27 is a cross-sectional side view of an embodiment of a manufacturing system.

FIG. 28 is a flow chart illustrating an embodiment of a method of using the breaker plate to produce the variable non-foam cushion.

FIG. 29 is a top view another embodiment of a breaker plate for dispensing resin used to manufacture non-foam/foamless cushions.

FIG. 30 is a cross-sectional view of a portion of the breaker plate of FIG. 29.

FIG. 31 is a zoomed in view of a single orifice from the breaker plate of FIG. 30.

FIG. 32 is a flow chart of a method of producing a vehicle interior component.

FIG. 33 is a flow chart of a method of manufacturing a product.

FIG. 34 is a flow chart of a method of manufacturing a product.

FIG. 35 is a flow chart of a method of assembling a seat.

FIG. 36 is a flow chart of a method forming a product.

FIG. 37 is a flow chart of a method of producing a vehicle interior component.

FIG. 38 is a flow chart of a method of producing a vehicle interior component.

FIG. 39 is a flow chart of a method of producing a vehicle interior component.

FIG. 40 is a flow chart of a method of producing a product such as a seat cushion.

FIG. 41 is a flow chart of a method of making a seat pad.

### DETAILED DESCRIPTION

Reference will now be made in detail to embodiments, examples of which are illustrated in the accompanying drawings. In the following detailed description, numerous specific details are set forth to provide a thorough understanding of the various described embodiments. It will be apparent to one of ordinary skill in the art, however, that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale and some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various embodiments herein is for the purpose of describing particular embodiments only and is not intended to be limiting. As used in the description of the various embodiments and the appended claims, the singular forms “a”, “an” and “the” are intended to include the plural forms as well, unless the context clearly indicates otherwise. It will be further understood that the terms “includes,” “including,” “comprises,” or “comprising,” when used in this specification, specify the presence of stated features, integers, steps, operations, elements, or components, but do not preclude the presence or addition of one or more other features, integers, steps, operations, elements, components, or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: percent, “parts of,” and ratio values are by weight. The term “polymer” includes “oligomer,” “copolymer,” “terpolymer,” and the like. Molecular weights provided for any polymers refers to weight average molecular weight unless otherwise indicated. The description of a group or class of materials as suitable or preferred for a given purpose in connection with the disclosure implies that mixtures of any two or more of the members of the group or class are equally suitable or preferred. Description of constituents in chemical terms refers to the constituents at the time of addition to any combination specified in the description and does not necessarily preclude chemical interactions among the constituents of a mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

As used herein, the term “and/or” means that either all or only one of the elements of said group may be present. For example, “A and/or B” shall mean “only A, or only B, or both A and B”. In the case of “only A”, the term also covers the possibility that B is absent, i.e., “only A, but not B”.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

With respect to the terms “comprising.” “consisting of.” and “consisting essentially of,” where one of these three terms is used herein, the presently disclosed subject matter can include the use of either of the other two terms.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

Filaments or strands may be used herein to refer to the generally linear polymeric units (although they may be fused together to form a mesh-like structure) after being dispensed through one or more orifices of the die, plate, die plate, tool, tooling plate, extrusion die, or breaker plate, or other variations thereof, which are likewise used to refer equivalent components. Similarly, the terms: consolidated filament structure, filament structure, yield strands, body, mesh, final member, nonfoam component, non-woven mesh, or cushion may refer to the same or similar components. The term funnel and cover may be used to refer to the same or similar components as well. The description herein may also use various terms to refer to a hole such as hole, orifice, nozzles, aperture, etc. In yet another example, tank, water tank, cooling chamber, liquid tank, and bath may refer to the same or similar components. The use of different terms to refer to the same or similar components may be used to avoid confusion when describing different preferred embodiments. The terms may be interchangeable as various components of features from various embodiments may be combined in manners not expressly described herein. This does not detract from the fact that certain terms may provide inherent detail not included by other interchangeable term unless expressly stated otherwise (e.g., water tank and liquid tank refer to similar interchangeable components although in at least one preferred embodiment, the tank is filled with water or arranged to be filled with water as opposed to any liquid when water tank is used.

In a refinement, the term interconnected refers to separate polymeric filaments that are entangled, intertwined, bonded, or otherwise bound to form a mesh body. However, interconnected does not refer to polymeric filaments that are manufactured separately and then fixed together by fasteners or thread.

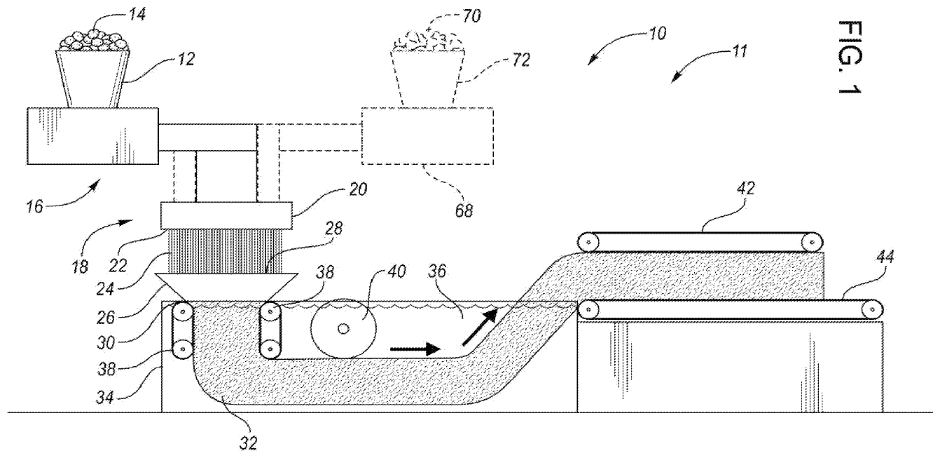

Referring to FIG. 1, a schematic illustration of a system 10 usable with a method 11 in accordance with embodiments described herein is shown. A hopper 12 holds solid granules of a polymeric material 14 that is to be extruded. In this embodiment, the material 14 is linear low-density polyethylene (LLDPE), although methods described herein may use different types of polymers as desirable and effective to produce the finished product. The material 14 is fed from the hopper 12 to an extruder 16. The extruder 16 melts and transports the material 14 to a die-plate arrangement 18, which includes a die plate 20. The extruder 16 may be, for example, a conventional extruder that includes a barrel that receives a rotatable screw. Rotation of the screw forces the material 14 to move through the barrel and helps heat the material because of the friction generated as the screw rotates. Heating elements may be disposed on the barrel and heat the polymeric material 14 inside the barrel.

The material 14 exits the extruder 16 at location 22 under pressure and in a molten state. Unless otherwise stated, the term “molten” as used herein means that the material is at least partially melted. It does not mean that the material is necessarily in a fully liquid state; rather, it means that the material is not completely solid and is still able to flow through elements of the system 10. For example, the molten material is still able to flow through the die plate 20, but it may be very viscous and starting to solidify. Once the solid granules of the polymeric material 14 are melted in the extruder 16, the material will begin to cool as it ceases to be agitated by the extruder screw and gets farther from any heaters. At different points in the process 11, the material may have a higher or lower viscosity, but if it is still partially melted and able to flow—even slowly—the term “molten” is applied herein.

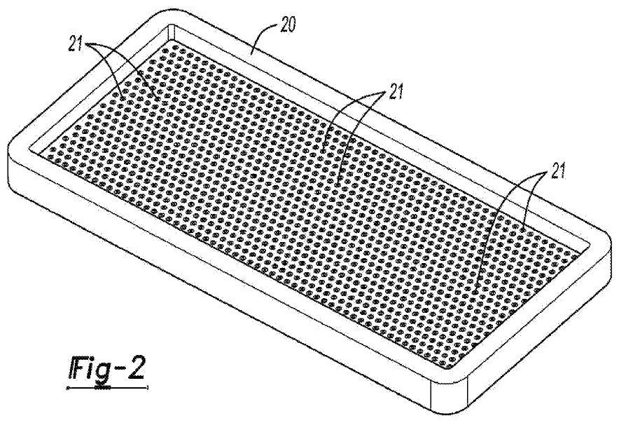

The die plate 20 extrudes the material 14 into filaments 24. More specifically, the die plate 20 has multiple holes 21 disposed therethrough—see, e.g., FIG. 2—through which the molten material 14 passes. A single filament 24 is extruded from each die-plate hole. The filaments 24 fall downward from the die plate 20 under system pressure and the force of gravity to a funnel 26. The funnel 26 helps consolidate or group the filaments 24 into a more compact arrangement in which the filaments 24 bend or loop, and each filament 24 contacts and bonds to at least one other filament 24. In this embodiment, the funnel 26 has a funnel inlet 28 and a funnel outlet 30 that is smaller than the funnel inlet 28. More specifically, the funnel 26 is narrower at the funnel outlet 30 than at the funnel inlet 28. Individual separated filaments 24 enter the funnel inlet 28, the filaments 24 then bend or loop and move into contact with each other as they accumulate and slide down the funnel 26 toward the funnel outlet 30, and the consolidated filament structure 32 exits the funnel outlet 30 and enters a water tank 34. When the filaments 24 reach the funnel 26, those filaments near the outer part of the funnel 26—approximately 2-3 rows—slide down an angled surface of the funnel 26, which creates a skin on the consolidated filament structure 32.

The water tank 34 holds water 36 and receives the consolidated filament structure 32 from the funnel 26. The water 36 performs at least two functions. First, it helps to temporarily support the consolidated filament structure 32 to prevent it from collapsing or condensing into a less open or less porous arrangement. As such, the water 36 provides some resistance that causes the additional bending and looping of the filaments 24 to further build the consolidated filament structure 32. Second, the water 36 cools the polymeric filaments 24 from the outside to solidify them. The temperature of the water 36 may be much less than the temperature of the filaments 24 as they leave the die plate 20, for example, it may be at the temperature of the ambient environment surrounding the tank 34. Although the fluid used in this embodiment is liquid water 36, in other embodiments, other types of fluids may be used.

The water tank 34 includes various rollers and conveyors that help move the consolidated filament structure 32 through and out of the water 36. A tractor conveyor 38 is submerged in the water 36 and engages opposing lateral sides of the consolidated filament structure 32 to move it away from the funnel 26 at approximately the same speed as the consolidated filament structure 32 exits the funnel 26. The gap between the opposing portions of the tractor conveyor 38 is slightly narrower than the width of the consolidated filament structure 32 to allow the tractor conveyor 38 to better grip the consolidated filament structure 32. As previously noted, FIG. 1 is a schematic representation and has been simplified for illustration purposes. For example, a conveyor, such as the tractor conveyor 38, may be located toward the front and back of the system 10 as it is oriented in FIG. 1, rather on the left and right sides as shown.

Another roller 40 helps keep the consolidated filament structure 32 submerged and helps guide it through the water 36 toward a conveyor belt 42 and a shaker table 44 that are positioned outside of the water tank 34. The shaker table 44 shakes the consolidated filament structure 32 while it is on the conveyor belt 42 to remove at least some of the water 36. Pressurized air may also be blown toward the consolidated filament structure 32, which may also be squeezed to remove more of the water 36. Finally, the consolidated filament structure 32 may be cut to a desired size and shape.

As described above, the filament structure 32 forms a stranded-mesh material that may be used, for example, as a cushion blank for part of a vehicle interior component. In some cases, the filament structure 32 may have a rectangular cross section that is later cut or shaped to a desired contour for its intended use. As shown in FIG. 2, a die plate, such as the die plate 20, may itself be rectangular and have a plurality of holes 21—only a few of which are labeled in FIG. 2 for clarity—that are of uniform diameter and “hole density”. As used in this context, the “hole density” is the number of holes per unit area in the die plate 20. In some applications, it may be desirable to have a filament structure that does not have a rectangular cross section, or which has portions that have higher or lower density than other portions. In some embodiments, both of these features may be combined.

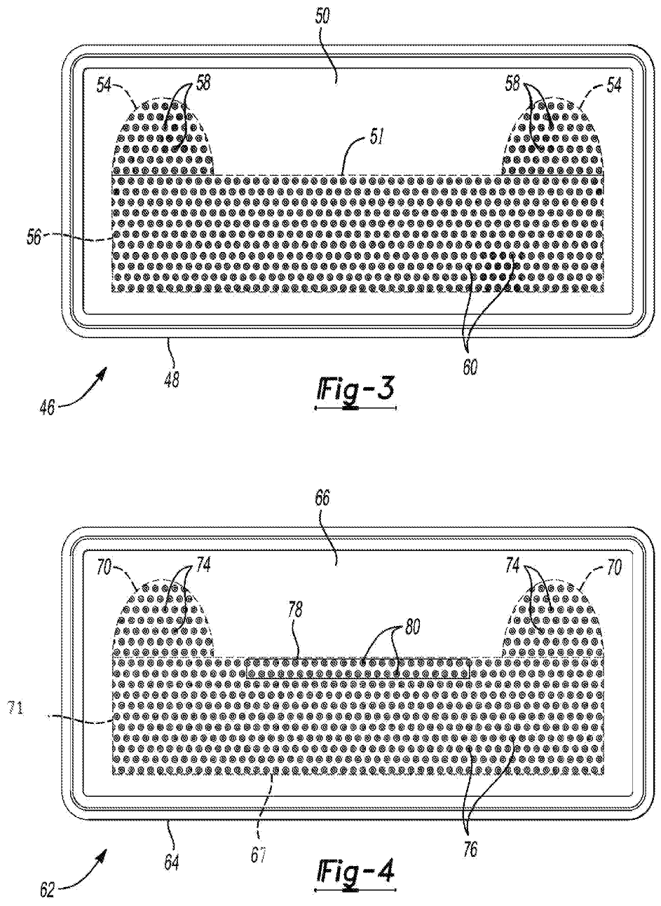

FIG. 3 shows a die-plate arrangement 46 that may be used, for example, in the method described in association with FIG. 1. The die-plate arrangement 46 includes a die plate 48 and a template 50. The die plate 48 is rectangular; however, the template 50 has a predefined outline portion 51, which in this embodiment is the inside perimeter of the template 50. The template 50 is used to mask a portion of the die plate 48 to provide a filament structure—for example, a cushion blank for a vehicle seat—that has a cross section that is defined by the predefined outline portion 51. In addition to providing a filament structure with a non-rectangular cross section, the die-plate arrangement 46 also provides a filament structure having a plurality of different densities. As used in this context, the “density” of the filament structure refers to the amount of material per volume. For example, in a vehicle seat, the seat bottom may include bolsters on the inboard and outboard sides of the seat. It may be desirable to have the bolsters be somewhat stiffer than the middle portion of the seat bottom where the occupant sits. One way to achieve this is to have a higher density of the filament material in the bolster areas as compared to the density of the filament material in the middle of the cushion.

As described above, the die plate 20 shown in FIG. 1 includes holes of a uniform diameter and hole density. In contrast, the hole density in the die plate 48 shown in FIG. 2 is not uniform. Rather, the die plate 48 includes a first area 54 indicated by the curved dashed line toward the left side of the drawing as shown in FIG. 3. In this embodiment, the die plate 48 includes another of the first areas 54, which is indicated by the curved dashed line toward the right side of the drawing as shown in FIG. 3. As explained in more detail below, the two first areas 54 are located in positions that correspond to the left and right bolster areas of a seat cushion. The die plate 48 also includes a second area 56, which is indicated by a rectangular dashed line shown in FIG. 3. It is understood that the shapes of the first areas 54 and the second area 56 may be different in different embodiments depending on the desired final product.

As shown in FIG. 3, each of the first areas 54 includes a plurality of first holes 58, and the second area 56 includes a plurality of second holes 60. In each case, only a few of the holes 58, 60 are labeled in FIG. 3 for clarity. It is understood, however, that each of the first and second areas 54, 56 may include dozens, hundreds, or more, of the first and second holes 58, 60. The first holes 58 together define an open space in the first areas 54. This open space may be compared to the entire area of the first areas 54, which defines an open space per unit area in the first areas 54. Stated another way, the first areas 54 have a closed portion defined by the die-plate material and an open portion defined by all the first holes 58. The total open area as defined by the first holes 58 makes up a certain portion of the first areas 54, and when this total open area is divided by the total area occupied by the first areas 54, it yields a number that may be considered an “open space per unit area”. And because this open space per unit area is in the first areas 54, it may be referred to as a “first open space per unit area”. Similarly, the total open area as defined by the second holes 60 in the second area 56 defines a second open space per unit area. In the embodiment shown in FIG. 3, the first open space per unit area is greater than the second open space per unit area, which results in a higher density of filament material in the first areas 54 as compared to the second areas 56.

Another way of considering the concept of “open space per unit area” as described above, is to define a ratio-specifically, a ratio of the open portion to the total portion in each of the first and second areas 54, 56. Stated another way, a ratio of the open portion of the first area—i.e., the total open area defined by the first holes 58—to the first areas 54 (in total) is greater than a ratio of the open portion of the second area to the second area 56 (in total). To achieve the difference in hole density between the first areas 54 and the second area 56, several different methods may be used. For example, in one embodiment the diameters of the holes 58, 60 may be the same, but the number of first holes 58 per unit area in the first areas 54 may be different from the number of second holes 60 per unit area in the second area 56. More specifically, there may be more of the first holes 58 per unit area in the first area 54 then there are second holes 60 per unit area in the second area 56. Alternatively, the number of first holes 58 per unit area may be the same as the number of second holes 60 per unit area, but the first holes 58 may have a larger diameter than the diameter of the second holes 60. In either case, the total amount of polymeric material per unit area flowing through the first areas 54 will be greater than the total amount of material per unit area flowing through the second area 56. The greater amount of material will result in a filament structure having a higher density in the first areas 54 than in the second area 56.

FIG. 4 shows a die-plate arrangement 62 in accordance with embodiments described herein. Similar to the die-plate arrangement 46 shown in FIG. 3, the die-plate arrangement 62 includes a die plate 64 and a template 66 that is configured to cover or mask a portion of the holes in the die plate 64. The template 66 has a predefined outline portion 67 that defines a cross section of the finished product—for example, a cushion for a vehicle seat. The die plate 64 includes a first area 70 and a second area 71 similar to those shown in the die plate 48 in FIG. 3. Also similar to the die plate 48, first and second areas of 70, 72 of the die plate 64 respectively include first holes 74 and second holes 76. One difference with the die plate 64, however, is that it includes a third area 78, which is indicated by the dashed line defining the small rectangle in FIG. 4.

The third portion 78 includes a plurality of third holes 81 disposed therethrough—again, only some of which are labeled for clarity. The third holes 81 together define a third open space per unit area in the third area 78. In this embodiment, the third open space per unit area is less than the second open space per unit area—in other words, a filament structure created using the die-plate arrangement 62 will have a lower density in the third area 78 than in the second area 71. This may be a convenient location to place an occupant sensor, such as a seat-belt reminder (SBR). The density of the third holes 81 in the third area 78 may also be defined as described above. That is, in the third area 78, a ratio of the open area to the total third area 78 will be less than the ratio of the open area in the second area 71 to the total second area 71. Although the die-plate arrangement 62 includes the third area 78, and the first and second areas 70, 71, other embodiments may not include the higher-density first areas 70 but may include only the lower density third area 78 within the second area 71.

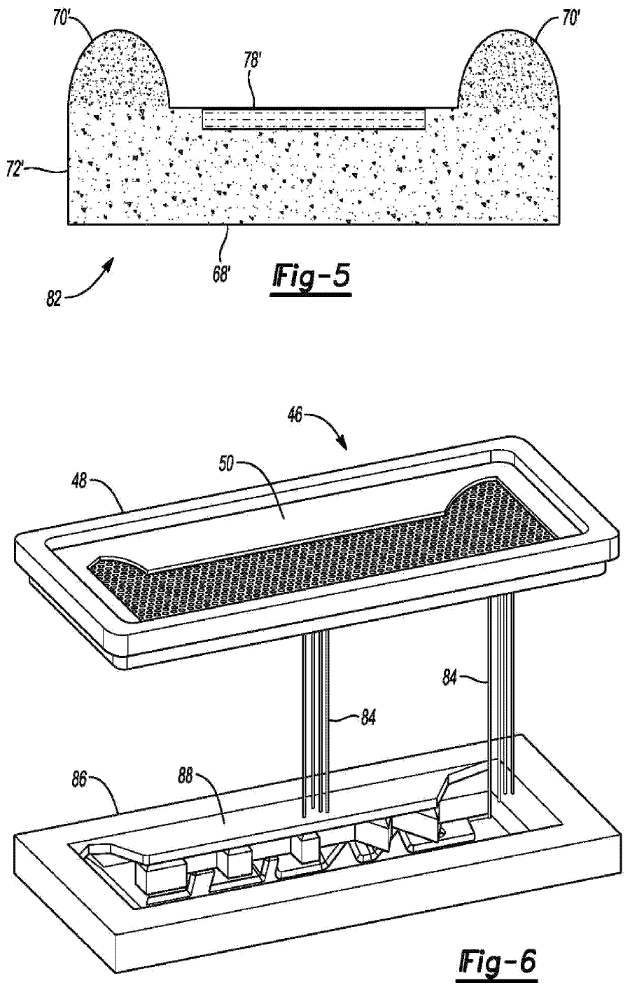

FIG. 5 shows a filament structure 82 produced as described above in conjunction with FIG. 1, using a die-plate arrangement, such as the die-plate arrangement 62 shown in FIG. 4. The filament structure 82 includes three areas, each of which corresponds to a respective area of the die plate 64. More specifically, the filament structure 82 includes two of the first areas 70′, where the prime (′) symbol is used on the numeric labels to designate corresponding areas from the die plate 64 shown in FIG. 4. The first areas 70′ are the areas of highest density in the filament structure 82 and correspond to the left and right bolsters of a vehicle seat cushion. As oriented in FIG. 5, the filament structure 82 is shown as a front cross-sectional view of a cushion blank for a seat bottom. As shown in FIG. 5, the filament structure 82 has a cross section 68′ that generally conforms to the predefined outline portion 68 of the template 66 shown in FIG. 4. In the filament structure 82, the second area 72′ has a lower density than the first areas 70′, and this lower density may provide a softer feel and more comfort to a seated occupant. The third area 78′ has the lowest density and provides a location for an SBR or other occupant sensors. It may be important for this area to be particularly soft so that it easily deflects to activate the sensor for even light-weight occupants.

To maintain the desired shape of the finished product, a die-plate arrangement, such as the die-plate arrangement 46, may be mated with a funnel—see, e.g., the funnel 26 shown in FIG. 1—having a corresponding geometric configuration. For example. FIG. 6 shows the die-plate arrangement 46, including the die plate 48 and the template 50. As described above in conjunction with FIG. 1, a molten polymer may be forced through the openings in the die plate 48 to yield strands 84 of material that will form a finished product after it is cooled. FIG. 6 shows a funnel 86 that also includes a template 88 configured similarly to the template 50 used with the die plate 48. The template 88 used with the funnel 86 helps to ensure that the desired shape of the finished product is maintained while the strands 84 fall from the die plate 48 and through the funnel 86.

A method 650 for producing a vehicle interior component is described. Method 650 includes heating 652 a polymeric material (e.g., 14) to a molten state, such that it becomes a molten polymer (as shown in FIG. 1).

Method 650 includes introducing 654 the molten polymer into a die plate (e.g., 20, 48, and/or 64) having a first area (e.g., bolster area 54) containing a plurality of first holes (e.g., 58) therethrough and a second area (e.g., cushion area 56) containing a plurality of second holes (e.g., 60) therethrough, the first holes (e.g., 58) together defining a first open space per unit area in the first area (e.g., 54) and the second holes (e.g., 60) together defining a second open space per unit area in the second area (e.g., 56), and wherein the first open space per unit area is greater than the second open space per unit area (i.e., bolster area has different/higher density than cushion area e.g., holes in the first area e.g., 54 allow more material to pass through than the holes in the second area).

Method 650 includes cooling 656 the molten polymer after it leaves the die plate (e.g., 20, 48, and/or 64).

In some embodiments, there are more of the first holes (e.g., 58) per unit area in the first area (e.g., 54) than the second holes (e.g., 60) per unit area in the second area (e.g., 56).

In some embodiments, the first holes (e.g., 58) have a larger diameter than the second holes (e.g., 60).

In some embodiments, cooling the polymer after it leaves the die plate (e.g., 20, 48, and/or 64) produces a cushion blank, the method further comprising masking a portion of the die plate (e.g., 20, 48, and/or 64) with a template having a predefined outline portion such that the cushion blank has a cross section that is defined by the predefined outline portion.

In some embodiments, the second area (e.g., 56) includes a location that corresponds to a location of an occupant sensor in the cushion blank (e.g., lower density area arranged adjacent an occupant sensors which activates a seat-belt reminder).

In some embodiments, the die plate (e.g., 20, 48, and/or 64) includes two of the first areas (e.g., 54), each being positioned in a location that corresponds to a respective bolster area of the cushion blank.

In some embodiments, the die plate (e.g., 20, 48, and/or 64) includes a third area (e.g., 78) containing a plurality of third holes (e.g., 81) therethrough, the third holes (e.g., 81) together defining a third open space per unit area in the third area (e.g., 78), and wherein the third open space per unit area is less than the second open space per unit area.

In some embodiments, a vehicle interior component formed by the method of any of the preceding claims.

A method 650 for producing a vehicle interior component is described. Method 650 includes heating a polymeric material (e.g., 14) to a molten state, such that it becomes a molten polymer.

Method 650 includes introducing 652 the molten polymer into a die plate (e.g., 20, 48, and/or 64) including a first area (e.g., 54) having an open portion and a closed portion and a second area (e.g., 56) having an open portion and a closed portion, and wherein a ratio of the open portion of the first area (e.g., 54) to the first area (e.g., 54) is greater than a ratio of the open portion of the second area (e.g., 56) to the second area (e.g., 56).

Method 650 includes cooling 654 the molten polymer after it leaves the die plate (e.g., 20, 48, and/or 64).

In some embodiments, the first area (e.g., 54) includes a plurality of first holes (e.g., 58) defining the open portion of the first area (e.g., 54), and the second area (e.g., 56) includes a plurality of second holes (e.g., 60) defining the open portion of the second area (e.g., 56), and wherein there are more of the first holes (e.g., 58) per unit area in the first area (e.g., 54) than the second holes (e.g., 60) per unit area in the second area (e.g., 56).

In some embodiments, the first area (e.g., 54) includes a plurality of first holes (e.g., 58) defining the open portion of the first area (e.g., 54), and the second area (e.g., 56) includes a plurality of second holes (e.g., 60) defining the open portion of the second area (e.g., 56), and wherein the first holes (e.g., 58) have a larger diameter than the second holes (e.g., 60).

In some embodiments, the vehicle interior component includes a cushion blank having a cross section, the method further comprising masking a portion of the die plate (e.g., 20, 48, and/or 64) with a template having an outline defining the cross section of the cushion blank.

In some embodiments, the die plate (e.g., 20, 48, and/or 64) includes a plurality of the first areas (e.g., 54), each being positioned in a location that corresponds to a respective bolster area of the cushion blank.

In some embodiments, the second area (e.g., 56) includes a location configured to receive an occupant sensor in the cushion blank.

In some embodiments, the die plate (e.g., 20, 48, and/or 64) further includes a third area (e.g., 78) having an open portion and a closed portion, and wherein the ratio of the open portion of the second area (e.g., 56) to the second area (e.g., 56) is greater than a ratio of the open portion of the third area (e.g., 78) to the third area (e.g., 78).

A die-plate arrangement usable to produce a vehicle interior component is described. The die-plate arrangement includes a plate including a first area (e.g., 54) containing a plurality of first holes (e.g., 58) therethrough and a second area (e.g., 56) containing a plurality of second holes (e.g., 60) therethrough, the first holes (e.g., 58) together defining a first open portion in the first area (e.g., 54) and the second holes (e.g., 60) together defining a second open portion in the second area (e.g., 56), and wherein a ratio of the first open portion to the first area (e.g., 54) is greater than a ratio of the second open portion to the second area (e.g., 56).

In some embodiments, there are more of the first holes (e.g., 58) per unit area in the first area (e.g., 54) than the second holes (e.g., 60) per unit area in the second area (e.g., 56).

In some embodiments, the first holes (e.g., 58) have a larger diameter than the second holes (e.g., 60).

In some embodiments, the die-plate arrangement further includes: a template configured to cover at least a portion of the first holes (e.g., 58), at least a portion of the second holes (e.g., 60), or at least a portion of the first holes (e.g., 58) and the second holes (e.g., 60), the template having a predefined outline portion defining a cross section of a portion of the vehicle interior component.

In some embodiments, the vehicle interior component is a seat cushion, and the plate includes two of the first areas (e.g., 54), each being positioned in a location that corresponds to a respective bolster area of the seat cushion.

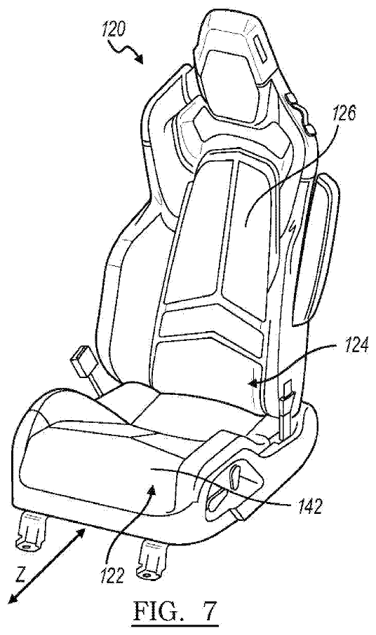

FIG. 7 illustrates a seat assembly 120 as a vehicle seat assembly 120 according to an embodiment. Although the vehicle seat assembly 120 is illustrated and described, any seat assembly 120 may be employed. The seat assembly 120 may be utilized in a land vehicle, aircraft, watercraft, or the like. The seat assembly 120 may also be utilized as an office chair, comfort chair, or the like.

The depicted seat assembly 120 includes a seat bottom cushion 122 to support a pelvis and thighs of a seated occupant. The seat assembly 120 also includes a seat back cushion 124 to support a back and shoulders of the seated occupant. A trim cover 26 is provided over the seat cushions 122, 124 to conceal the cushions 122, 124 and provide a uniform and smooth contact surface for the occupant.

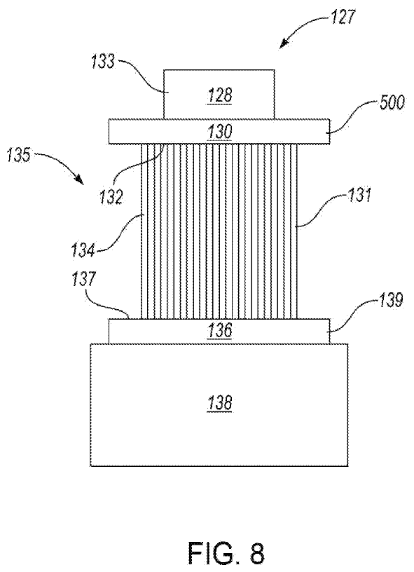

Referring now to FIG. 8, the seat cushions 122, 124 are manufactured from a system 127 and a process of extruded thermoplastic resin mesh. In the depicted embodiment, an extruder 128 provides a pressurized molten thermoplastic resin to an extrusion die 130. The extrusion die 130 is arranged with a plurality of outlet ports or nozzles 132 to dispense a plurality of strands 134 of the molten thermoplastic resin. The strands 134 are dispensed through a tool 136 and into a fluid chamber 138. The tool 136 guides the strands 134 into the fluid chamber 138. The fluid chamber 138 may retain a fluid to resist and cool the strands 134, such as a water. The fluid chamber 138 resists a flow of the strands 134, thereby causing the strands 134 to buckle, loop, and intersect with adjacent strands 134 within a profile defined by the tool 136. The strands 134 may also expand and float within the fluid chamber 138. The strands 134 are cooled in the fluid chamber 138 by the fluid to form a unitary non-woven thermoplastic cushion 122. According to this process the non-woven thermoplastic cushion 122 is resisted, cooled, and solidified by the fluid.

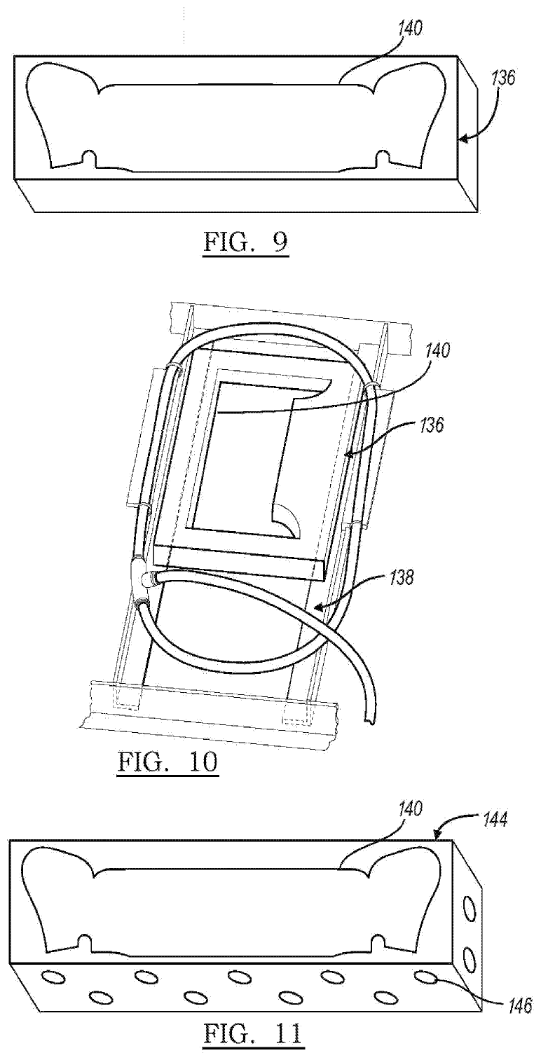

FIGS. 9 and 10 illustrate the tool 136 as a plate 136, referred to as a funnel plate 136. An aperture 140 is formed through the plate 136 to guide and funnel the strands 134 of thermoplastic resin into the cooling chamber 138. The through aperture 140 is sized to match an overall profile or perimeter of the seat bottom cushion 122 when viewed in a fore and aft direction, labeled Z in FIG. 7. Therefore, the] molten resin strands 134 are collected, guided, and cooled into a cushion 122 with an overall profile of the seat cushion 122. The plate 136 shapes the mesh of molten resin strands 134 into the overall profile of the cushion 122 as the strands 134 buckle, loop, and intersect. The plate 136 shapes the mesh before the mesh solidifies into the non-woven mesh assembly of the cushion 122.

The through aperture 140 is provided with curvature to form the non-woven cushion 122 with curvature. For example, the through aperture 140 has an overall convex profile to form a concave surface 142 on a top surface of the cushion 122 as a central seating surface. The through aperture 140 may also include a fillet or chamfer about the aperture 140 at an input end of the plate 136. The fillet may have a radius of at least twelve millimeters, or the chamfer may be sized twelve millimeters by twelve millimeters. The fillet or chamfer provide a leading edge about the aperture 140 to guide the strands 134 into the plate aperture 140.

Seat cushions 122, 124 are often molded from a foam material. Foam cushions require dedicated tooling to mold each cushion component. In contrast to prior art mold tooling, the seat cushion 122 includes a dedicated tooling plate 136. The system 127 includes flexible equipment suitable for fabricating various cushions with various tooling plates. The extrusion die 130 includes a plurality of nozzles 132 that exceed an overall area of the through aperture 140. When utilized with the tool plate 136, the nozzles that are outside of the perimeter of the through aperture 140 are closed so that the extruded strands 134 are dispensed into the aperture 140 only. The closed or open operation of each nozzle 132 can be adjusted for each tooling plate 136.

The tooling plate 136 induces a shape upon the cushion 122 before the strands 134 cool, cure, and solidify into the non-woven mesh cushion material. Secondary forming processes to create shape, contour, seating surfaces, and connection surfaces can be eliminated. The cushion 122 is cut from the otherwise continuous formed mesh assembly. Alternatively, the cushion 122 may be formed from a plurality of mesh assembly segments with a sequentially transitioning overall profile, which are combined within the trim cover 126. The segments may be glued or otherwise fastened together.

The tooling plate 136 may have a suitable thickness beyond twelve millimeters. For example, the tooling plate 136 may have a thickness of at least one inch. With reference now to FIG. 11, the tool 136 may be a tunnel mold 144 with a greater thickness than the tooling plate 136. For the depicted example, the mold 144 has a thickness of six inches. The mold 144 includes the through aperture 140 formed through the mold 144 in the thickness direction to guide the molten thermoplastic resin strands 134 into the fluid chamber 138.

The mold 144 also includes a plurality of cooling passages 146 formed into a body of the mold 144, as shown in FIG. 11. The cooling passages 146 extend toward the through aperture 140 to permit coolant to cool the mold 144 and consequently the mesh material within the cavity of the aperture 140. The mold 144 may extend into the fluid of the chamber 138 so that the mold 144 is cooled by the fluid of the chamber 138 and so that the fluid is also disposed within the aperture 140 to cool and form the non-woven mesh. Cooling of the mold 144 begins the cooling of the mesh strands 134 and forming of the shape of the cushion 122 while the strands 134 and fluid are within the cavity of the aperture 140 of the mold 144. Cooling of the mold 144 also maintains the mold 144 at a suitable temperature for repeated molding cycles for multiple mesh assemblies. According to an embodiment, the cooling passages 146 do not intersect with the through aperture 140. According to another embodiment, the cooling passages 146 intersect with the through aperture 140 to permit the fluid to pass from the cooling passages to the cavity within the through aperture 140.

A method 150 of manufacturing a product is described. Method 150 includes dispensing 152, through a tool (e.g., 136) with an aperture (e.g., 140) sized to match an overall perimeter of a product, a molten thermoplastic resin, the tool (e.g., 136) generating a plurality of strands (e.g., 134) through the tool aperture (e.g., 140) while maintaining the plurality of strands (e.g., 134) within the overall perimeter of the product.

Method 150 includes buckling 154 the strands (e.g., 134) by resisting a flow of the plurality of strands (e.g., 134), the buckled strands (e.g., 134) intersecting as a unitary non-woven body in a shape of the overall perimeter of the product.

In some embodiments, method 150 includes cooling 156 the plurality of strands (e.g., 134) as a unitary non-woven product.

In some embodiments, method 150 dispensing the molten thermoplastic resin from a plurality of nozzles, the plurality of nozzles, collectively, comprising an area greater than the area of the aperture (e.g., 140) and closing a subset of the plurality of nozzles outside the area of the aperture (e.g., 140).

In some embodiments, method 150 includes providing a die plate as the tool (e.g., 136).

In some embodiments, method 150 includes cooling the tool (e.g., 136).

In some embodiments, method 150 includes providing a mold (e.g., 144) with the aperture (e.g., 140) as the tool (e.g., 136).

In some embodiments, method 150 includes providing cooling passages (e.g., 146) through the mold (e.g., 144) to cool the unitary non-woven product.

In some embodiments, method 150 includes placing the mold (e.g., 144) in a cooling fluid, the cooling fluid cooling the unitary non-woven product.

A product manufactured according to a method 160. The method includes dispensing 162, through a tool (e.g., 136) with an aperture (e.g., 140) sized to match an overall perimeter of a product, a molten thermoplastic resin, the tool (e.g., 136) generating a plurality of strands (e.g., 134) through the tool aperture (e.g., 140) while maintaining 163 the plurality of strands (e.g., 134) within the overall perimeter of the product.

The method includes buckling 164 the strands (e.g., 134) by resisting a flow of the plurality of strands, the buckled strands (e.g., 134) intersecting as a unitary non-woven body in a shape of the overall perimeter of the product.

In some embodiments, the product further comprises a unitary non-woven cushion.

In some embodiments, the product further comprises a concave contoured perimeter.

A tool (e.g., 136) is described. The tool (e.g., 136) includes a tool body with a through aperture (e.g., 140), the through aperture (e.g., 140) sized to match an overall perimeter of a cushion, the through aperture (e.g., 140) configured to receive a molten thermoplastic resin as a plurality of dispensed strands (e.g., 134).

The tool through aperture (e.g., 140) is configured to maintain the plurality of dispensed strands (e.g., 134) within the overall perimeter of the cushion.

In some embodiments, the through aperture (e.g., 140) is shaped as a seat cushion, the through aperture (e.g., 140) configured to form a unitary non-woven cushion.

In some embodiments, the through aperture (e.g., 140) is shaped with curvature, the through aperture (e.g., 140) configured to form a unitary non-woven cushion with curvature.

In some embodiments, the through aperture (e.g., 140) is provided with a plurality of curvatures of at least twelve millimeters radii.

In some embodiments, the through aperture (e.g., 140) is formed with a convex perimeter to form a concave surface on the cushion.

A system to manufacture a cushion is described. The system includes a dispenser of molten thermoplastic resin. The system includes a tool (e.g., 136) oriented relative to the dispenser to receive the molten thermoplastic resin.

In some embodiments, the system further includes a fluid chamber to receive the molten thermoplastic resin to resist a flow of the plurality of dispensed strands (e.g., 134) to buckle the strands (e.g., 134) to intersect as a unitary non-woven body in a shape of the overall perimeter of the cushion.

In some embodiments, the tool (e.g., 136) is oriented within the fluid chamber to cool the plurality of dispensed strands (e.g., 134) as a unitary non-woven cushion.

In some embodiments, cooling passages are formed through the tool (e.g., 136) to cool the plurality of dispensed strands (e.g., 134) as the unitary non-woven cushion.

FIG. 7 illustrates a seat assembly 120 as a vehicle seat assembly 120 according to an embodiment. Although the vehicle seat assembly 120 is illustrated and described, any seat assembly 120 may be employed. The seat assembly 120 may be utilized in a land vehicle, aircraft, watercraft, or the like. The seat assembly 120 may also be utilized as an office chair, comfort chair, or the like.

The depicted seat assembly 120 includes a seat bottom cushion 122 to support a pelvis and thighs of a seated occupant. The seat assembly 120 also includes a seat back cushion 124 to support a back and shoulders of the seated occupant. A trim cover 126 is provided over the seat cushions 122, 124 to conceal the cushions 122, 124 and provide a uniform and smooth contact surface for the occupant.

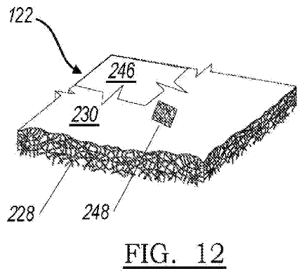

Referring now to FIG. 12, one of the seat cushions 122 is partially illustrated disassembled from the seat assembly 120. The seat cushion 122 is formed from a plurality of strands 228 of an extruded, expanded thermoplastic resin. The seat cushion 122 is also formed with a layer or film 230 of extruded thermoplastic resin bonded to, and formed unitarily with, the plurality of strands 228.

Referring now to FIG. 7, the seat cushions 122, 124 are manufactured from a system 10 and a process of extruded thermoplastic resin mesh. A hopper 12 holds material stock that is to be extruded, e.g., as solid granules or pellets of the material. The material may be provided by plastic, such as a linear low-density polyethylene (LLDPE). The material is fed from the hopper 12 to an extruder 16.

The extruder 16 melts and transports the material to a die plate 20. In one non-limiting example, the extruder 16 includes a barrel that receives a rotatable screw, as well as heating elements. Rotation of the screw forces the material to move through the barrel and helps heat the material due to the friction generated as the screw rotates. The material exits the extruder 16 under pressure and in a molten state.

The die plate 20 extrudes the material into filaments 24. The die plate 20 may be provided as described below depending on the direction of the extrusion relative to the final member 122, 124 produced from it. More specifically, the die plate 20 has multiple small circular, through holes or apertures through which the molten material passes. A single filament 24 is extruded from each die plate hole. The filaments 24 fall downward from the die plate under system pressure and the force of gravity to a funnel 26 as described below. The funnel 26 may have a cross-sectional shape that is the same as, or is different than, a shape collectively defined by the apertures in the die plate.

The funnel 26 helps consolidate or group the filaments 24 into a more compact arrangement in which the filaments 24 bend or loop and each filament 24 contacts and bonds to at least one other filament 24. The funnel 26 has a funnel inlet 28 and a funnel outlet 30 that is smaller than the funnel inlet. The funnel 26 is narrower at the funnel outlet 30 than at the funnel inlet 28. Individual separated filaments 24 enter the funnel inlet 28, the filaments 24 bend/loop and move into contact as they accumulate and slide down the funnel 26 toward the funnel outlet, and the consolidated filament structure 32 exits the funnel outlet 30 and immediately enters a water tank.

A liquid tank 34 holds water 36 or another fluid and receives the consolidated filament structure 32 from the funnel 26. The liquid 36 in the bath 34 helps temporarily support the consolidated filament structure 32 to prevent the filament structure from collapsing or condensing into a less open or less porous arrangement and helps maintain the desired porosity and density. As such, the liquid 36 provides some resistance that causes additional bending and looping of the filaments 24 to further build the consolidated filament structure 32. Second, the liquid 36 cools the filaments 24 from the outside to solidify the filaments 24 and prevent the filaments 24 from bonding at additional locations.

The tank 34 includes various rollers and conveyors that help move the consolidated filament structure 32 through the liquid 36 and out of the liquid 36, such as a tractor conveyor 38. The rollers and conveyors speed may be controlled to move the consolidated filament structure 32 away from the funnel 26 at a speed that is dependent on the speed that the consolidated filament structure 32 exits the funnel 26.

Other rollers, such as roller 40 helps keep the consolidated filament structure 32 submerged in the liquid 36 and guides the consolidated filament structure 32 through the liquid 36 toward a conveyor belt 42 and shaker table 44 that are disposed outside of the tank 34. The shaker table 44 shakes the consolidated filament structure 32 while it is on the conveyor belt 42 to remove liquid 36. Pressurized air may additionally or alternatively be blown toward the consolidated filament structure 32, and/or the consolidated filament structure 32 may be squeezed to remove liquid 36. The consolidated filament structure 32 may then be cut to a desired size and shape.

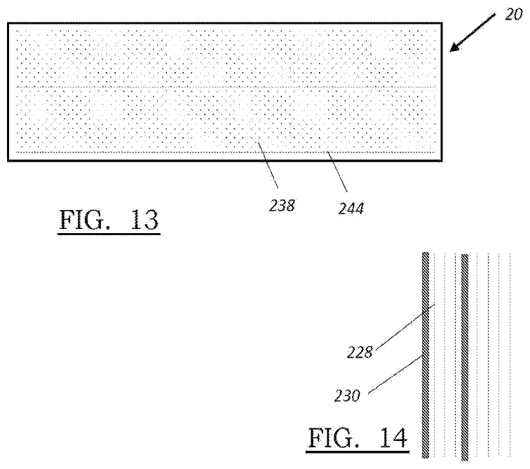

FIG. 13 illustrates the top plan view of an extrusion die 20, according to an embodiment. The extrusion die 20 includes the plurality of apertures or nozzles 238 formed therethrough to extrude the strands 228. The die 20 also includes a plurality of slits 244 formed therethrough to extrude the film 230 concurrently with the strands 228. The strands 228 each have a small cross-section to generate an elongate material that is readily bent, buckled, and otherwise bonded in various directions to form the mesh pattern of the cushion 122. The film 230 has a cross section with a width that is wide enough to cover a majority or entirety of the cushion 22. The film 230 also has a relatively narrow thickness to provide a continuous layer 230 upon the cushion 122. In the depicted embodiment, the slit 244 has a parallel thickness to provide a planar film 230. However, any cross section slit 244 may be employed. The slit 244 may also have a thickness greater than a diameter of the strands 228.

FIG. 14 illustrates an uninterrupted flow of the molten thermoplastic resin of strands 228 and the films 230 from the extrusion die 20. Unless otherwise stated, the term “molten” as used herein means that the material is at least partially melted. It does not mean that the material is necessarily in a fully liquid state; rather, it means that the material is not completely solid and is still able to flow through elements of the system 10. For example, the molten material is still able to flow through the die plate 20, but it may be very viscous and starting to solidify. Once the solid granules of the polymeric material are melted in the extruder 16, the material begins to cool as it ceases to be agitated by the extruder screw and gets farther from any heaters. At different points in the process 11, the material may have a higher or lower viscosity, but if it is still partially melted and able to flow—even slowly—the term “molten” is applied herein.

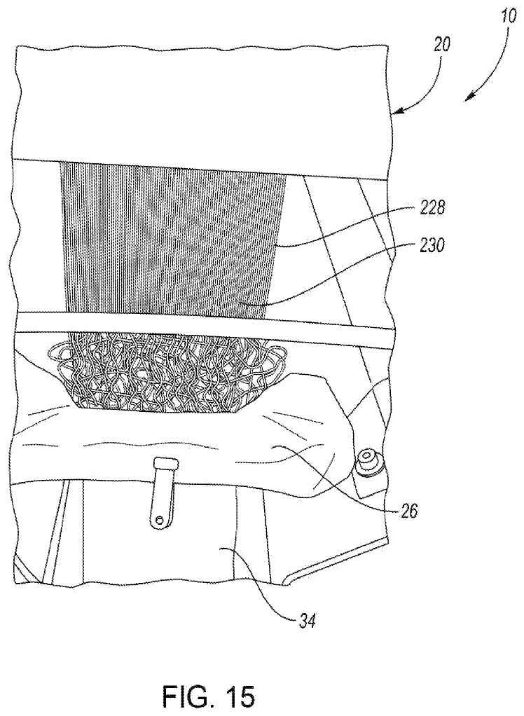

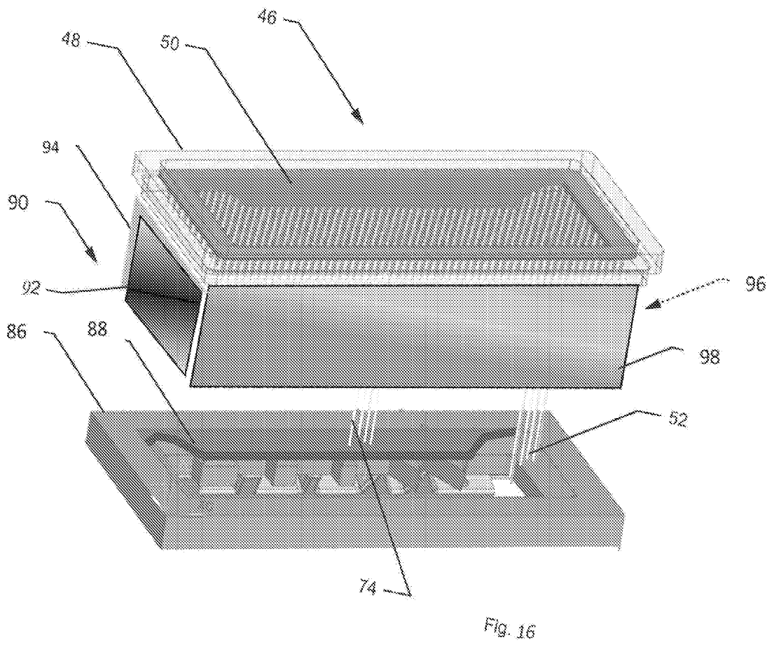

FIG. 15 also illustrates the extrusion of the strands 228 and the films 230 from the extrusion die 20. In FIG. 15, the molten strands 228 and films 230 are illustrated entering into the funnel plate 26 for passing through to the cooling chamber 34. In the cooling chamber 34, flow of the strands 228 is resisted by the fluid to buckle, bend, and bond with each other, and so that a subset of the strands 228 also engage and bond the films 230. The strands 228 and the films 230 also cool and solidify within the cooling chamber 34 so that the strands 228 and the films 230 form a unitary body as the cushion 122.

The films 230 may also bend or otherwise deform in the fluid chamber 34. The increased thickness of the films 230 relative to the strands 228 is optimized to resist deformation to the films 230 for a relatively flat film 230. As illustrated in FIGS. 12, 13, and 14, one of the films 230 is formed on an exterior surface of the cushion 122. FIGS. 13, 14, and 15 also illustrate that another one of the films 230 is formed within the cushion 122 and in between two subsets of the strands 228.

The exterior film 230 provides a surface tension for a continuous seating surface across the cushion 122 similar to a skin along a foam cushion for support and comfort to the occupant. The films 230 also provide surfaces for attaching other seating components by an adhesive, a hook and loop fastener, or the like. As illustrate in FIG. 12, another layer 246 is attached to the exterior film 230. According to one embodiment, the layer 246 is the trim cover. According to another embodiment, the layer 246 is an actuator, such as an air bladder assembly. According even another embodiment, the layer 246 is a heat transfer layer such as a heating mat.

The films 230 are formed impermeable across an area to contain an air permeable region of the cushion 122 formed from the mesh of strands 228 to provide a boundary to close off the mesh 228 for ventilation. An aperture 248 is formed through the film 230 to install a vent, ducting, plenum, or the like for conveying fluid through the cushion 122 for heating or cooling of the occupant. The aperture 248 is formed through the film 230 is a post extrusion operation, such as a stamping or cutting operation.

Although two parallel films 230 are illustrated in FIGS. 13-15, any quantity of films 230 at any angular orientation may be developed based on the arrangement of the slits 244 in the extrusion die 20. The temperature and pressure of the extruder 16 may also be varied to vary the thickness or flatness of the films 230.

Seat cushions 122, 124 are often molded from a foam material. Foam cushions require dedicated tooling to mold each cushion component. In contrast to prior art mold tooling, the seat cushion 122 includes a dedicated extrusion die 20. The system 10 includes flexible equipment suitable for fabricating various cushions with various extrusion dies 20. After fabricating a quantity of the cushions 122, the extrusion die 20 is removed from the extruder 16. Then, another extrusion die 20 is installed with a specific aperture 238 and slit 244 pattern for another cushion 122. Then a quantity of the second cushions 122 are extruded through the second extrusion die 20.

A method 170 of forming a foamless cushion with a film (e.g., 230) is described. Method 160 includes dispensing 172 (e.g., from an extruder) a molten thermoplastic resin as a plurality of strands (e.g., 228) and at least one film (e.g., 230).

Method 170 includes resisting 174 (e.g., with a fluid such as water) a flow of the dispensed plurality of strands (e.g., 228), the resisting expanding the plurality of strands (e.g., 228) by intersecting and bonding at least a subset of the plurality of strands (e.g., 228) with each other and the at least one film (e.g., 230) as a unitary body.

In some embodiments, method 170 includes cooling 176 the plurality of strands (e.g., 228) and the at least one film (e.g., 230) as a unitary product.

In some embodiments, method 170 includes cooling the plurality of strands (e.g., 228) and the at least one film (e.g., 230) with a fluid, wherein the flow of the plurality of strands (e.g., 228) is resisted by the fluid.

In some embodiments, method 170 includes cooling the plurality of strands (e.g., 228) in a fluid chamber.

In some embodiments, method 170 includes dispensing the at least one film (e.g., 230) on an exterior surface of the unitary body.

In some embodiments, method 170 includes dispensing the at least one film (e.g., 230) between at least two subsets of the plurality of strands (e.g., 228).

In some embodiments, method 170 includes forming an aperture through the at least one film (e.g., 230).

In some embodiments, dispensing further comprises dispensing the plurality of strands (e.g., 228) through a plurality of apertures in a tool; and dispensing the at least one film (e.g., 230) through at least one slit in the tool.

In some embodiments, method 170 includes removing the tool from an extruder; installing a second tool to the extruder; dispensing the molten thermoplastic resin as a second plurality of strands (e.g., 228) and a second film (e.g., 230) through the second tool; and resisting a flow of the dispensed second plurality of strands (e.g., 228), the resisting expanding the second plurality of strands (e.g., 228) by intersecting at least a subset of the second plurality of strands (e.g., 228) with each other and the second film as a second unitary body that is different from the first unitary body.

In some embodiments, method 170 includes assembling a seat with a cushion formed by the method.

A product is described. The product is formed by the method of any of the preceding techniques.

A product is formed by a method 170. Method 180 includes dispensing 172 a molten thermoplastic resin as a plurality of strands (e.g., 228) and at least one film (e.g., 230).

Method 170 includes resisting 174 a flow of the dispensed plurality of strands (e.g., 228), the resisting expanding the plurality of strands by intersecting at least a subset of the plurality of strands (e.g., 228) with each other and the at least one film (e.g., 230) as a unitary body.

In some embodiments, method 170 includes forming the at least one film (e.g., 230) on an exterior surface of the unitary body.

In some embodiments, method 170 includes forming the at least one film (e.g., 230) as an impermeable film (e.g., 230) between at least two subsets of the plurality of strands (e.g., 228).

In some embodiments, method 170 includes forming an aperture through the at least one film (e.g., 230).

A seat assembly is manufactured by a method 180. Method 180 includes assembling 182 a seat with a cushion formed by the techniques described above.

In some embodiments, method 180 includes attaching 184 at least one of a seat trim, an actuator, and/or a heat transfer layer to the at least one film (e.g., 230).

A product is described. The product includes an expanded mesh of a plurality of interconnected thermoplastic strands (e.g., 228) and at least one thermoplastic film (e.g., 230) integrally bonded to at least one subset of the plurality of strands (e.g., 228) as a unitary body.

In some embodiments, the at least one film (e.g., 230) is oriented on an exterior surface of the unitary body.

In some embodiments, the at least one film (e.g., 230) is impermeable.

In some embodiments, the at least one film (e.g., 230) is oriented between at least two subsets of the plurality of strands (e.g., 228).

In some embodiments, an aperture extends through the at least one film (e.g., 230).

A seat assembly comprises the product of any of the above techniques, as a seat cushion.

In some embodiments, the seat assembly includes at least one of a seat trim, an actuator, and/or a heat transfer layer attached to the at least one film (e.g., 230).

A tool is described. The tool comprises a body with a plurality of apertures formed through the body and at least one slit formed through the body to dispense a molten thermoplastic resin through the plurality of apertures and the at least one slit.

A system is described. The system comprising: an extruder of molten thermoplastic resin; and the tool of claim 65 mounted to the extruder to dispense the molten thermoplastic resin through the tool as a plurality of strands (e.g., 228) and at least one film (e.g., 230).

Referring to FIG. 1, a schematic illustration of a system 10 usable with a method 11 in accordance with embodiments described herein is shown. A hopper 12 holds solid granules of a polymeric material 14 that is to be extruded. In this embodiment, the material 14 is linear low-density polyethylene (LLDPE), although methods described herein may use different types of polymers as desirable and effective to produce the finished product. The material 14 is fed from the hopper 12 to an extruder 16. The extruder 16 melts and transports the material 14 to a die-plate arrangement 18, which includes a die plate 20. The extruder 16 may be, for example, a conventional extruder that includes a barrel that receives a rotatable screw. Rotation of the screw forces the material 14 to move through the barrel and helps heat the material because of the friction generated as the screw rotates. Heating elements may be disposed on the barrel and heat the polymeric material 14 inside the barrel.

The material 14 exits the extruder 16 at location 22 under pressure and in a molten state. Unless otherwise stated, the term “molten” as used herein means that the material is at least partially melted. It does not mean that the material is necessarily in a fully liquid state; rather, it means that the material is not completely solid and is still able to flow through elements of the system 10. For example, the molten material is still able to flow through the die plate 20, but it may be very viscous and starting to solidify. Once the solid granules of the polymeric material 14 are melted in the extruder 16, the material will begin to cool as it ceases to be agitated by the extruder screw and gets farther from any heaters. At different points in the process 11, the material may have a higher or lower viscosity, but if it is still partially melted and able to flow—even slowly—the term “molten” is applied herein.

The die plate 20 extrudes the material 14 into filaments 24. A single filament 24 is extruded from each die-plate hole. The filaments 24 fall downward from the die plate 20 under system pressure and the force of gravity to a funnel 26. The funnel 26 helps consolidate or group the filaments 24 into a more compact arrangement in which the filaments 24 bend or loop, and each filament 24 contacts and bonds to at least one other filament 24. In this embodiment, the funnel 26 has a funnel inlet 28 and a funnel outlet 30 that is smaller than the funnel inlet 28. More specifically, the funnel 26 is narrower at the funnel outlet 30 than at the funnel inlet 28. Individual separated filaments 24 enter the funnel inlet 28, the filaments 24 then bend or loop and move into contact with each other as they accumulate and slide down the funnel 26 toward the funnel outlet 30, and the consolidated filament structure 32 exits the funnel outlet 30 and enters a water tank 34. When the filaments 24 reach the funnel 26, those filaments near the outer part of the funnel 26—approximately 2-3 rows—slide down an angled surface of the funnel 26, which creates a skin on the consolidated filament structure 32.

The water tank 34 holds water 36 and receives the consolidated filament structure 32 from the funnel 26. The water 36 performs at least two functions. First, it helps to temporarily support the consolidated filament structure 32 to prevent it from collapsing or condensing into a less open or less porous arrangement. As such, the water 36 provides some resistance that causes the additional bending and looping of the filaments 24 to further build the consolidated filament structure 32. Second, the water 36 cools the polymeric filaments 24 from the outside to solidify them. The temperature of the water 36 may be much less than the temperature of the filaments 24 as they leave the die plate 20, for example, it may be at the temperature of the ambient environment surrounding the tank 34. Although the fluid used in this embodiment is liquid water 36, in other embodiments, other types of fluids may be used.

The water tank 34 includes various rollers and conveyors that help move the consolidated filament structure 32 through and out of the water 36. A tractor conveyor 38 is submerged in the water 36 and engages opposing lateral sides of the consolidated filament structure 32 to move it away from the funnel 26 at approximately the same speed as the consolidated filament structure 32 exits the funnel 26. The gap between the opposing portions of the tractor conveyor 38 is slightly narrower than the width of the consolidated filament structure 32 to allow the tractor conveyor 38 to better grip the consolidated filament structure 32. As previously noted, FIG. 1 is a schematic representation and has been simplified for illustration purposes. For example, a conveyor, such as the tractor conveyor 38, may be located toward the front and back of the system 10 as it is oriented in FIG. 1, rather on the left and right sides as shown.

Another roller 40 helps keep the consolidated filament structure 32 submerged and helps guide it through the water 36 toward a conveyor belt 42 and a shaker table 44 that are positioned outside of the water tank 34. The shaker table 44 shakes the consolidated filament structure 32 while it is on the conveyor belt 42 to remove at least some of the water 36. Pressurized air may also be blown toward the consolidated filament structure 32, which may also be squeezed to remove more of the water 36. Finally, the consolidated filament structure 32 may be cut to a desired size and shape.

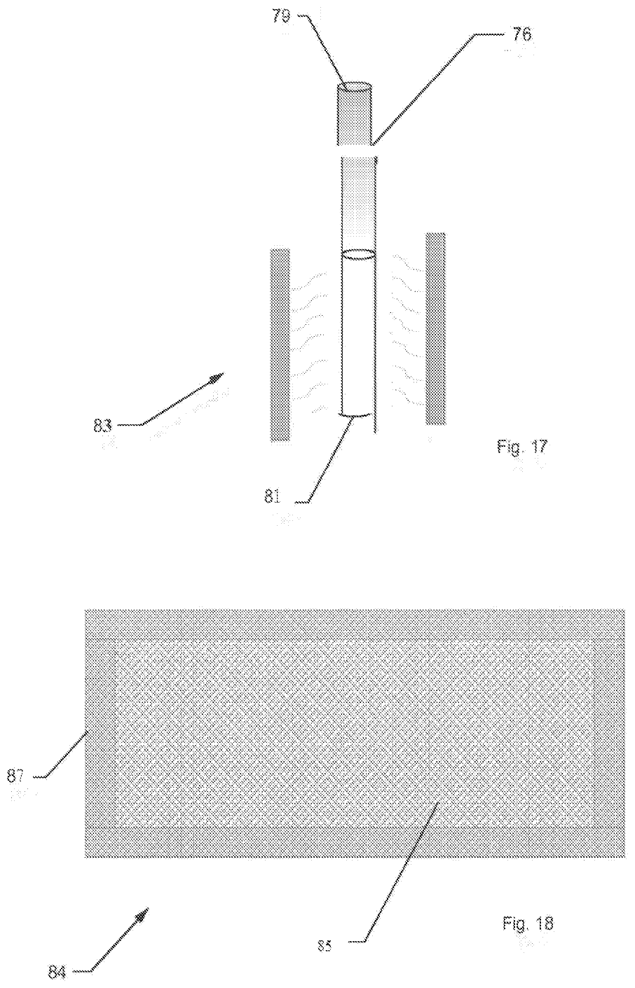

FIG. 16 shows a die-plate arrangement 46, including a die plate 48 and a template 50, which may be used to impart a particular shape to a finished product. As described above in conjunction with FIG. 1, a molten polymer may be forced through the openings in the die plate 48 to yield molten polymeric filaments 52—only some of which are labeled in FIG. 17 for clarity—of material that will form a finished product after it is cooled. A funnel 86 also includes a template 88 configured similarly to the template 50 used with the die plate 48. The template 88 used with the funnel 86 helps to ensure that the desired shape of the finished product is maintained while the filaments 52 fall from the die plate 48 and through the funnel 86.

As the filaments 52 fall from the die plate 48, they will begin to cool as they approach the funnel 86. Even though the filaments 52 will ultimately be cooled in a fluid bath—see e.g., the water tank 34 shown in FIG. 1—it may be desirable to have the filaments 52 maintain their temperature longer before they reach the funnel 86. To achieve this result, embodiments described herein may include using a heating arrangement 90 to surround the molten polymeric filaments 52 as they fall from the die plate 48 to the funnel 86. In the embodiment shown in FIG. 16, the heating arrangement 90 is a rectangular heating structure that heats the filaments 52 on four sides. It includes four heating plates 92, 94, 96, 98, which heat an entire perimeter of the molten polymeric filaments 52. Although the heating plates 92, 94, 96, 98 surround the filaments 52 as they fall from the die plate 48, FIG. 16 shows them as having gaps between them at the four corners. In practice, it may be convenient to have a heating arrangement, such as the heating arrangement 90, surround the associated filaments without having any spaces or gaps around the perimeter of the filaments.

Embodiments described herein contemplate the use of different types of heating arrangements, including different geometric configurations, distances from the associated filaments, and the amount of heat generated. For example, in some embodiments, a heating arrangement, such as the heating arrangement 90, may use radiant heat as the sole or primary source of thermal control. In other embodiments, convection heaters—or some combination of convection heaters and radiant heaters—may be used. In the embodiment shown in FIG. 16, the heating plates 92, 94, 96, 98 are placed between 100 millimeters (mm) and 150 mm from the outermost filaments 52. Thus, the heating arrangement 90 is positioned at least 100 mm-150 mm from any of the filaments 52. The heating arrangement 90 can be operated to control an ambient temperature around the molten polymeric filaments 52 to a temperature of 60° C.-140° C., although in other embodiments, temperatures outside this range may be used, depending on the application and the desired properties of the finished product. In the embodiment shown in FIG. 16, the heating arrangement 90, and specifically, the heating plates 92, 94, 96, 98 are attached directly to the die plate 48, although in other embodiments, a heating arrangement may be self-supporting or may be attached to a structure other than the associated die plate.

There may be numerous advantages to heating the molten polymeric filaments, such as the filaments 52, as they leave the die plate and before they reach the associated funnel. For example, the heating arrangement 90 is configured to heat an outer portion of the filaments 52 and can be operated to maintain a constant temperature around the outside of the filaments 52 so there is uniform bonding between the filaments 52. Without a heating arrangement, such as the heating arrangement 90, ambient conditions may affect of the filaments 52 differently from others as they fall to the funnel 26. This could lead to inconsistent bonding between the filaments 52 on different parts of the finished product. In contrast, by heating an entire perimeter of the molten polymeric filaments 52, the bonding can be consistently maintained. In addition, adding heat as the filaments 52 fall from the die plate 48 may create stronger bonds between the filaments 52 by either keeping them at their melting temperature longer, or by having them melt to an even greater liquid state as they travel downward. This may provide a stronger or tougher outside portion of a finished product—i.e., a type of “shell” may be formed—which may be desirable in some applications.

Another benefit of using a heating arrangement, such as the heating arrangement 90, is that it may work in conjunction with a second or “co-extruded” material added to the method 11 shown in FIG. 1. Shown in phantom in FIG. 1 is another extruder 68 configured to receive a polymeric material 70 from a hopper 72. The polymeric material 70 is different from the polymeric material 14, which is fed into the extruder 16 from the hopper 12. Similar to the extruder 16, the extruder 68 heats the material 70 to a molten state and moves it to the die-plate arrangement 18. The material 70 may be conveniently referred to as a first material, and after it is heated it may be referred to as a first molten polymer 70. Similarly, the material 14 may be conveniently referred to as a second material, and after it is heated it may be referred to as a second molten polymer. As shown in FIG. 1, the extruder 68 is positioned such that it feeds the first molten polymer 70 toward an outside edge of the die plate 20 where it will form a plurality of first molten polymeric filaments that will at least partially surround second polymeric filaments 24.

The relationship between the inner and outer polymeric filaments created with a co-extrusion system is illustrated in FIG. 16. Specifically, the molten polymeric filaments 52 are made from a first molten polymer and are positioned near the outside edge of the die plate 48. In contrast, a second group of molten polymeric filaments 74—only some of which are labeled in FIG. 16 for clarity—are made from a second molten polymer and are positioned inward from the first molten polymer. With this configuration, the first molten polymeric filaments 52 at least partially surround the second molten polymeric filaments 74. As previously noted. FIG. 16 is a schematic representation of the actual process, and some elements are removed for clarity. In practice, the area below the die plate 48 leading into the funnel 26 would be crowded with many more of the first and second molten polymeric filaments 52, 74 than are illustrated.

Regardless of whether a single material is used, or multiple materials are used in a co-extrusion process, embodiments described herein provide advantages based on the use of a heating arrangement to control the temperature of the molten polymeric filaments leaving a die plate. FIG. 17 shows a single molten polymeric filament 76 just after leaving the die plate. More specifically, a top portion 79 of the molten polymeric filament 76 is positioned just below the die plate from which it was extruded, while a bottom portion 80 of the filament 76 is positioned near an entrance to a funnel, such as the funnel 26 shown in FIG. 17. Without the use of a heating arrangement, such as the heating arrangement 90 shown in FIG. 17, the top portion 79 of the filament 76 will be much hotter than the bottom portion 80. There will be a temperature gradient between the top portion 79 and the bottom portion 80, which may or may not be uniform depending on the ambient conditions surrounding the filament 76. In the embodiment shown in FIG. 17, however, a heating arrangement 83 is positioned around the filament 76 to control the ambient temperature, and ultimately the temperature of the filament 76 itself.

Although FIG. 17 shows the heating arrangement 83 on only two sides of the filament 76, it is understood that the heating arrangement 83 may be configured to surround the filament—and indeed all the filaments exiting the die plate—such as illustrated in FIG. 16. As described above, controlling the temperature of the molten polymeric filaments as they leave a die plate may provide desirable features in a finished product. FIG. 18 shows a cross section of a consolidated filament structure 84 made in accordance with embodiments of systems and methods described herein. As shown in FIG. 18, the consolidated filament structure 84 includes an outer portion 87 positioned around the perimeter, and an inner portion 85 positioned inward from the outer portion 87.

As shown in FIG. 18, the outer portion 87 is different from the inner portion 85. For example, the outer portion 87 may have better bonding between the individual filaments because of the use of a heating arrangement, such as the heating arrangement 90 shown in FIG. 17. And as a result, it may also be denser. Alternatively, the outer portion 87 may comprise a first group of molten polymeric filaments made from a first material, while the inner portion 85 may comprise a second group of molten polymeric filaments made from a second material that is different from the first material. In at least some embodiments, two different materials may be used in conjunction with a heating arrangement to provide a finished product having a first material around the outside of the product, which is also more strongly bonded and denser than a second material positioned inward from the first material. Therefore, embodiments as described herein provide a system and method with the flexibility to control the properties of a finished product through the use of different materials and heat control.

A method 190 for producing a vehicle interior component is disclosed. Method 190 includes heating 191 a polymeric material (e.g., 14 and/or 70) to a molten state, such that it becomes a molten polymer.

Method 190 includes introducing 192 the molten polymer into a die plate (e.g., 48) having a plurality of holes disposed therethrough such that the molten polymer moves through the holes and forms a plurality of molten polymeric filaments.

Method 190 includes surrounding 193 the molten polymeric filaments with a heating arrangement (e.g., 92-98) operable to apply heat to the molten polymeric filaments.

Method 190 includes introducing 186 the molten polymeric filaments into a bath to cool the molten polymeric filaments to form a consolidated filament structure.

In some embodiments, the heating arrangement (e.g., 92-98) comprises a rectangular heating structure to surround the molten polymeric filaments as the molten polymeric filaments leave the die plate (e.g., 48).

In some embodiments, the die plate (e.g., 48) includes a plurality of sides, and the heating arrangement is attached to each of the sides of the die plate (e.g., 48).

In some embodiments, the heating arrangement is configured to control an ambient temperature around the molten polymeric filaments to a temperature of 60 C-140 C.

In some embodiments, the heating arrangement is positioned at least 100 mm-150 mm from the molten polymeric filaments.

In some embodiments, the molten polymeric filaments include an outer portion (e.g., 87) disposed toward an outside edge of the die plate (e.g., 48), and an inner portion (e.g., 85) disposed inward from the outer portion (e.g., 87), and the heating arrangement is configured to heat the outer portion (e.g., 87) such that bonding between the molten polymeric filaments of the outer portion (e.g., 87) is greater than bonding between the molten polymeric filaments of the inner portion (e.g., 85).

In some embodiments, the molten polymer is a first molten polymer comprising a first material and the molten polymeric filaments are first molten polymeric filaments, and the method further comprises introducing a second molten polymer comprising a second material into the die plate (e.g., 48) such that the second molten polymer moves through the holes in the die plate (e.g., 48) and forms a plurality of second molten polymeric filaments.

In some embodiments, the first molten polymer is introduced into the die plate (e.g., 48) toward an outside edge of the die plate (e.g., 48), and the second molten polymer is introduced into the die plate (e.g., 48) inward from the first molten polymer such that the first molten polymeric filaments at least partially surround the second molten polymeric filaments.

A vehicle interior component is formed by any of the above techniques.

A method 194 for producing a vehicle interior component is disclosed. Method 194 includes heating 195 a first polymeric material to a molten state to create a first molten polymer.

Method 194 includes extruding 196 the first molten polymer to form a plurality of first molten polymeric filaments. Method 194 includes heating 197 an entire perimeter of the first molten polymeric filaments. Method 194 includes cooling 198 the first molten polymeric filaments in a fluid bath to create a consolidated filament structure.

In some embodiments, the first molten polymer comprises a first material, and the method further comprises extruding a second molten polymer comprising a second material to form a plurality of second molten polymeric filaments.

In some embodiments, the first molten polymer and second molten polymer are extruded such that the first molten polymeric filaments at least partially surround the second molten polymeric filaments.

In some embodiments, heating the entire perimeter of the first molten polymeric filaments comprises heating the first molten polymeric filaments on four sides of the first molten polymeric filaments.

In some embodiments, heating the entire perimeter of the first molten polymeric filaments comprises heating the first molten polymeric filaments to a temperature of 60 C-140 C.

In some embodiments, the entire perimeter of the first molten polymeric filaments is heated such that bonding between the first molten polymeric filaments is greater than bonding between the second molten polymeric filaments.

A vehicle interior component is formed by any of the above techniques.

A method 200 for producing a vehicle interior component. Method 200 includes heating 202 a polymeric material to create a molten polymer. Method 200 includes forming 204 a plurality of molten polymeric filaments from the molten polymer by extruding the molten polymer through a die plate (e.g., 48). Method 200 includes heating 206 an entire perimeter of the molten polymeric filaments with a heating arrangement. Method 200 includes cooling 208 the molten polymeric filaments in a fluid bath to form a consolidated filament structure.

In some embodiments, the heating arrangement is attached to the die plate (e.g., 48).

In some embodiments, the molten polymer is a first molten polymer comprising a first material and the molten polymeric filaments are first molten polymeric filaments, and the method further comprises introducing a second molten polymer comprising a second material into the die plate (e.g., 48) such that the second molten polymer moves through the die plate (e.g., 48) and forms a plurality of second molten polymeric filaments.

In some embodiments, the first molten polymer is introduced into the die plate (e.g., 48) toward an outside edge of the die plate (e.g., 48), and the second molten polymer is introduced into the die plate (e.g., 48) inward from the first molten polymer such that the first molten polymeric filaments at least partially surround the second molten polymeric filaments.

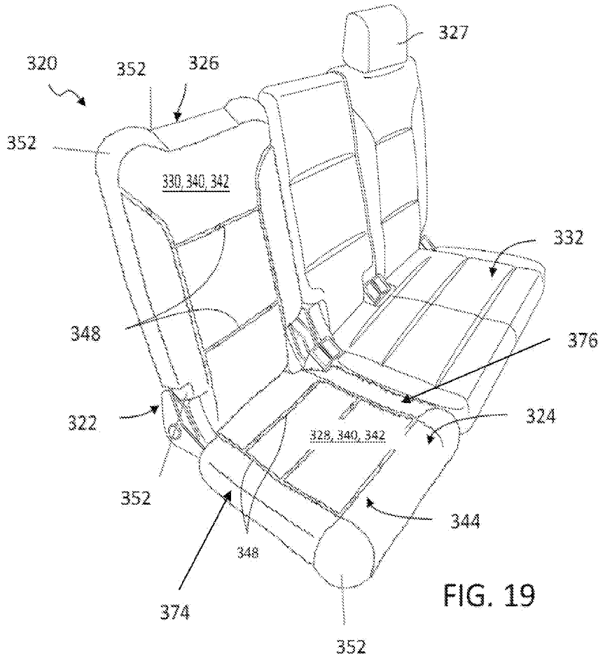

Referring to FIG. 19, a seat assembly 320, such as a vehicle seat assembly 320 is illustrated. In other examples, the seat assembly 320 may be shaped and sized as a front row driver or passenger seat, a second, third, or other rear row seat, and may include bench-style seats as shown, bucket seats, or other seat styles. Furthermore, the seat assembly 320 may be a non-stowable seat or a stowable seat that may be foldable and stowable in a cavity in the vehicle floor. Additionally, the seat assembly 320 may be configured for use with other non-vehicle applications.

The seat assembly 320 optionally includes a frame 322 or other support structure. The seat assembly 320 has seat components, and these seat components include at least a seat bottom 324 and a seat back 326. The seat bottom 324 may be sized to receive a seated occupant to support a pelvis and thighs of the occupant. The seat back 326 may be sized to extend upright from the seat bottom 324 to support a back of the occupant. The seat assembly 320 may additionally have a head restraint 327, with the head restraint 327 illustrated for an adjacent seat assembly only. The seat bottom 324 has a seat bottom cushion 328. The seat back 326 has a seat back cushion 330. The frame 3] 22 may include wire suspension mats or other structure to support the cushions 328, 330.

The frame 322 provides rigid structural support for the seat components, e.g., the seat bottom 324 and seat back 326, and may be provided as multiple frame members that are moveable relative to one another to provide adjustments for the seat assembly. The frame may be formed from a stamped steel alloy, a fiber reinforced polymer, or any suitable structural material. The frame 322 may further include a substrate, e.g., a panel, to support the associated cushion.

One or more trim covers 332 are used to cover the seat bottom cushion 328 and the seat back cushion 330 and provide a seating surface for the seat assembly 320. The vehicle seat assembly 320 is shown without a trim cover, and the adjacent seat assembly illustrates the trim cover 332. In one example, the trim cover 332 covers both of the cushions 328, 330. In other examples, multiple trim covers are provided to cover the seat bottom cushion and the seat back cushion. The trim cover 332 may be formed from one or more panels of a fabric, leather, leatherette, vinyl, or other material.

A seating cushion 340 is described in further detail below, and the description may similarly be applied to the seat bottom cushion 328 or the seat back cushion 330.

In the example shown, the seating cushion 340 includes at least one nonfoam component or member 342. In one example, and as shown, the seating cushion 340 is formed solely from the nonfoam component 342, such that the nonfoam component 342 provides all of the cushioning for the seat component between the frame 322 and the trim cover 332. In other examples, the seating cushion 340 may be formed from a nonfoam component 342 as well as one or more foam components, such as a component formed from molded polyurethane foam, or other nonfoam components. The seating cushion 340 may have the nonfoam and foam components positioned to provide different regions of the cushion 340 for the seating component. Alternatively, or additionally, the seating cushion 340 may have a thin foam or other material layer positioned between the nonfoam component 342 and the trim cover 332 to provide additional cushioning for one or more regions of the seating component. Furthermore, the seat assembly 320 may have a heating pad or heating mat positioned between the cushion 340 and the trim cover 332. By removing some or all of the traditional foam from the seating cushion 340, the seat assembly 320 may be provided with improved support and comfort, and reduced weight.

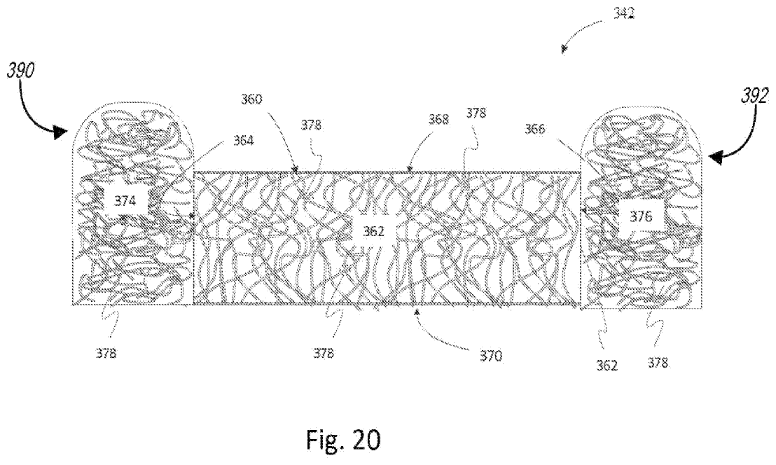

FIG. 20 depict a cross-section of a nonfoam component 342 in accordance with an embodiment of the present disclosure. Advantageously, the nonfoam component 342 is a vehicle seatback or a vehicle seat bottom. Nonfoam component 342 includes plastic mesh base 360. Plastic mesh base 360 includes a first shaped plurality 362 of three-dimensional filament loops composed of a first thermoplastic polymer. In this context, the first shaped plurality 362 of three-dimensional filament loops have a general block shape or any shape suitable to function as a cushion. Plastic mesh base 360 has a first edge 364, a second edge 366, a first face 368, and a second face 370. A first bolster 374 is attached to the plastic mess base at the first edge 364. A second bolster 376 is attached to the plastic mesh base 360 at the second edge 366. The loops stick to each other.

In at least one embodiment, the first bolster 374 includes a second shaped plurality 390 of three-dimensional filament loops composed of a thermoplastic polymer. In this context, the second shaped plurality 390 of three-dimensional filament loops have a general bolster shape or any shape suitable to function as a side bolster. In at least one embodiment, the second bolster 376 includes a third shaped plurality 392 of three-dimensional filament loops composed of a thermoplastic polymer. In this context, the third shaped plurality 392 of three-dimensional filament loops have a general bolster shape or any shape suitable to function as a side bolster. In at least one embodiment, the first and second bolsters 374 and 376 have the same shape. In at least one embodiment, as best seen in FIG. 19, a third (front) bolster 344 can be provided at the front of the nonfoam component 342.

In one non-limiting example, the nonfoam component or member 342 of the seating cushion 340 is formed by at least two different stranded mesh material, also known as an entangled three-dimensional filament structure. The stranded-mesh materials are made from a polymeric mesh having a plurality of integrated polymeric strands. The stranded-mesh materials may be made from, for example, two or more linear low-density polyethylene (LLPDE) materials, although other polymers and materials effective to provide the desired properties and functionality are contemplated. In one non-limiting embodiment, the stranded-mesh material may be formed using extruded filaments of two or more linear low-density polyethylenes (LLDPE) that are randomly entangled, bent, looped, or otherwise positioned and oriented, and directly bonded to each other to provide a porous mesh structure, an example of which is shown in a closer view in FIG. 20.

In at least one embodiment, as shown in FIG. 20 for instance, the second shaped plurality 390 of three-dimensional filament loops is composed of a second thermoplastic polymer, different from the first thermoplastic polymer. In at least one embodiment, the third shaped plurality 392 of three-dimensional filament loops is composed of the second thermoplastic polymer. In yet another embodiment, the third shaped plurality 392 of three-dimensional filament loops is composed of a third thermoplastic polymer, different from the first and second thermoplastic polymers. In still yet another embodiment, the optional third bolster 344 is made of a shaped plurality of three-dimensional filament loops composed of one of the first, second or third thermoplastic polymers, or yet a fourth thermoplastic polymer, different from the first, second and third thermoplastic polymers.

Referring to, e.g., FIG. 20, at least a subset of loops in the plurality of three-dimensional filament loops are not parallel or aligned with each other. In a refinement, loops in the plurality of three-dimensional filament loops are randomly oriented, the plastic mesh base is from 60 to 95 volume percent air. In a refinement, the plastic mesh base has a density from about (1.5-3.5 lbs/ft³ or 24-56 kg/m³). In some refinement, the plurality of three-dimensional filament loops includes a plurality of fused or bonded connections 378 in which two loops are attached to each other. In a refinement, the three-dimensional filament loops are an extruded thermoplastic polymer. Examples of the thermoplastic polymer include, but are not limited to polyolefin, polystyrene-based thermoplastic elastomer, polyester-based thermoplastic elastomer, polyurethane-based thermoplastic elastomer, and polyamide-based thermoplastic elastomer. In a refinement, the thermoplastic polymer includes linear low-density polyethylene. In some refinement, the three-dimensional filament loops have a fineness from 200 to 10000 decitex. In a refinement, the three-dimensional filament loops have a fineness from 200 to 5000 dtex. In a further refinement, the three-dimensional filament loops have a fineness from 200 to 3000 dtex.

In at least one embodiment, the first, second, third and/or fourth thermoplastic polymers can independently be any suitable thermoplastic elastomers (TPE), like LLDPE, thermoplastic polyether ester elastomer (TPEE), thermoplastic polyurethane (TPU), styrenic thermoplastic elastomer (TPS), or thermoplastic vulcanizates (TPV). In at least one embodiment, the first, second, third and/or fourth thermoplastic polymers can independently vary from one or more of the other to provide a variable density at various locations of the nonfoam component 342. For instance, the first and/or second bolster 374, 376 could have a higher density than the mesh base 360.

In at least one embodiment, the first thermoplastic polymer that comprises the first shaped plurality 362 of three-dimensional filament loops is composed of LLDPE (Linear Low Density Polyethylene) having a first density while one or more of the second, third and fourth thermoplastic polymers that comprises the second shaped plurality 390 of three-dimensional filament loops, the third shaped plurality 392 of three-dimensional filament loops, and the shaped plurality of three-dimensional filament loops that make up the first, second and third bolsters 374, 376 and 344, respectively is composed of a LLDPE (Linear Low Density Polyethylene) having a second density greater than the first density. In addition, or alternatively, to varying densities, the first shaped plurality 362 of three-dimensional filament loops is composed of first material having a first characteristic while one or more of the second, third and fourth thermoplastic polymers that comprises the second shaped plurality 390 of three-dimensional filament loops is composed of a second material having a different characteristic than the first characteristic. Examples of other different characteristics, in addition to density, can include different (such as higher or lower) bonding quality or heat resistance.

A method is provided, and may be used to form the member 342, assemble the cushion 340, and assemble the seat assembly 320. In various examples, the method may have greater or fewer steps than described below, and various steps may be performed in another order, sequentially, or simultaneously.

FIG. 1 illustrates a method and manufacturing process 10 to form a stranded mesh material member such as member 342 for the cushion 340, and for use with the method according to an embodiment. The method may be used to form a member for a cushion, such as member 342 described above, and further may be used to assemble a seat such as seat assembly 320. In various examples, the method may have greater or fewer steps than described below, and various steps may be performed in another order, sequentially, or simultaneously.

Referring to FIG. 1, a consolidated filament structure 32 is formed. This consolidated filament structure 32 may provide the stranded mesh material from which the cushion 340 and member 342 as described above is formed.

Referring to FIG. 1, a first hopper 12 holds a first material stock that is to be extruded, e.g., as solid granules or pellets of the material. The first material may be provided by plastic, such as a linear low-density polyethylene (LLDPE). The first material is fed from the first hopper 12 to a first extruder 16.

A second hopper 72 is also provided that holds a second material stock that is to be extruded, e.g., as solid granules or pellets of the material. The second material may be provided by plastic, such as a linear low-density polyethylene (LLDPE) being a different grade than the LLDPE of the first material. For instance, the second material could be a different grade (grade 1, grade 2, etc.) or different type (TPEE, TPV, etc.). The second material is fed from the second hopper 72 to a second extruder 68.

The first and second extruders 16 and 72 melt the first and second materials 14 and 70 respectively and transport the molten first and second materials 14 and 70 to a die plate 20, respectively. The molten first and second materials do not mix with each other. Thus, the first and second extruders 16 and 72 coextrude the first and second materials respectively to the die plate 130. In one non-limiting example, the extruders 16 and 72 include a barrel that receives a rotatable screw, as well as heating elements. Rotation of the screw forces the first and second materials 14 and 70 to move through the respective barrels and helps heat the first and second material 14 and 70 due to the friction generated as the screws rotate. The first and second materials 14 and 70 exit the extruders 16 and 72 under pressure and in a molten state.

The die plate 20 extrudes the first and second materials into filaments 24. More specifically, the filaments comprise a first plurality of filaments 24′ made of the first material, a second plurality of filaments 24″, and an optional third plurality of filaments 24″. In at least one embodiment, one or both of the second plurality of filaments 24″ and the third plurality of filaments 24′″ are made of the second material. Alternately, one of the second plurality of filaments 24″ and the third plurality of filaments 24′″ could be made of the first material. Still further, in at least one embodiment, the first plurality of filaments 24′, the second plurality of filaments 24″, and the third plurality of filaments 24′″ could all be made of different materials, either by material type and/or by grade.

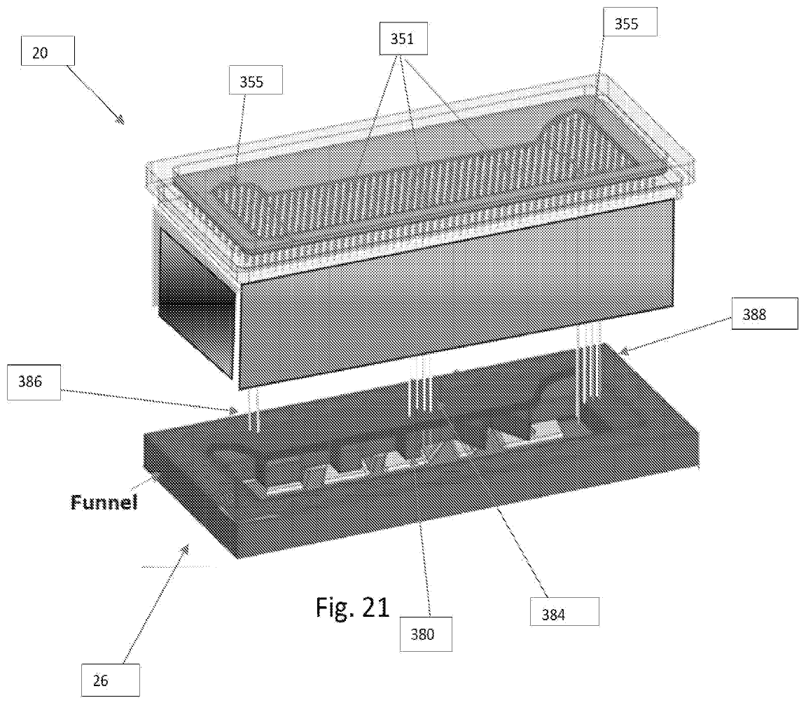

The die plate 20 may be provided as described below depending on the direction of the extrusion relative to the final member 342 produced from it. More specifically, the die plate 20 has multiple small circular through holes or apertures 351 through which the molten material passes, as shown in FIG. 21. A single filament 380, 384, 386, 388 is extruded from each die plate hole. The die plate 20 has a central portion 351 and two side portion 355 on opposite sides of the central portion 351. The first material is extruded from the central portion 351 to form filaments 384 that form the plastic mesh base 360 and one or both of the two side portions 355 extrudes a different material from the first material, such as the second material and optionally the third material, to form the first bolster 374 and the second bolster 376. The filaments 140 fall downward from the die plate under the pressure and the force of gravity to a funnel 26 as described below. The funnel 26 may have a cross-sectional shape that is the same as or is different than a shape collectively defined by the apertures in the die plate.

The funnel 26 helps consolidate or group the filaments 380 into a more compact arrangement in which the filaments 380 bend or loop and each filament 380 contacts and bonds to at least one other filament 380. The funnel 26 has a funnel inlet 28 and a funnel outlet 30 that is smaller than the funnel inlet 28. The funnel 26 is narrower at the funnel outlet 30 than at the funnel inlet 28. Individual separated filaments 380 enter the funnel inlet 28, the filaments 380 bend/loop and move into contact as they accumulate and slide down an angled surface of the funnel 26 toward the funnel outlet 30 creating a material skin utilizing 2-3 rows of filaments, and the consolidated filament structure 32 exits the funnel outlet 30 and immediately enters a water tank 34.

A liquid tank 34 holds water 36 or another fluid and receives the consolidated filament structure 32 from the funnel 26. The liquid 36 in the bath 34 helps temporarily support the consolidated filament structure 32 to prevent the filament structure from collapsing or condensing into a less open or less porous arrangement and maintain the desired porosity and density. As such, the liquid 36 provides some resistance that causes additional bending looping of the filaments 380 to further build the consolidated filament structure 32. Second, the liquid 36 cools the filaments 380 from the outside to solidify the filaments 380 and prevent the filaments 380 from bonding at additional locations.

The tank 34 includes various rollers and conveyors that help move the consolidated filament structure 32 through the liquid 36 and out of the liquid 36, such as a tractor conveyor 38. The rollers and conveyors speed may be controlled to move the consolidated filament structure 32 away from the funnel 26 at a speed that is dependent on the speed that the consolidated filament structure 32 exits the funnel 26.

Other rollers, such as roller 40 helps keep the consolidated filament structure 32 submerged in the liquid 36 and guides the consolidated filament structure 32 through the liquid 36 toward a conveyor belt 42 and shaker table 44 that are disposed outside of the tank 34. The shaker table 44 shakes the consolidated filament structure 32 while it is on the conveyor belt 42 to remove liquid 36. Pressurized air may additionally or alternatively be blown toward the consolidated filament structure 32, and/or the consolidated filament structure 32 may be squeezed to remove liquid 36. It should be noted that components 12, 72, 16, 20 and 26 are shown in front view in FIG. 1, while for better understanding, components 34, 38, 40, 42, and 44 and funnels are shown from a side view.

In one example, the consolidated filament structure 32 may be generally formed with two or more of the surfaces for the member 342 based on the shape of the die 20 and the funnel 26. In other examples, the consolidated filament structure 32 may require further processing as described below to reach the desired shape of the member 342.

The consolidated filament structure 32 is then cut to a desired size and shape to form the outer perimeter, or overall or outer shape of the member 342. After forming the member 342, the seat assembly 320 can be assembled. The member 342 is attached to a frame 322 of a seat assembly to provide a cushion 340 therefor. A trim cover 332 may be positioned over the member 342 and cushion 340. The trim cover 332 may be connected to the cushion 340 and/or the frame 322. In one example, the trim cover 332 may be connected via tie downs or other fasteners.

In a variation, three-dimensional filament loops and the optional skin layers if present are composed of a thermoplastic polymer.

A vehicle seat cushion component is described. The vehicle seat cushion component includes a plastic mesh base (e.g., 360), the plastic mesh base (e.g., 360) comprising a first plurality of three-dimensional filament loops, the first plurality of three-dimensional filament loops composed of a first thermoplastic polymer, the plastic mesh base (e.g., 360) having a first side edge, a second side edge, a front edge, a rear edge, a first face, and a second face.

The vehicle seat cushion component includes a first bolster attached to the plastic mesh base (e.g., 360) at the first edge, the first foamed bolster comprising a second plurality of three-dimensional filament loops, the second plurality of three-dimensional filament loops composed of a second thermoplastic polymer different from the first thermoplastic polymer. The vehicle seat cushion component includes a second bolster attached to the plastic mesh base (e.g., 360) at the second edge.

In some embodiments, the second bolster comprises a third plurality of three-dimensional filament loops, the third plurality of three-dimensional filament loops composed of the second thermoplastic polymer.

In some embodiments, the second bolster comprises a third plurality of three-dimensional filament loops, the third plurality of three-dimensional filament loops composed of a third thermoplastic polymer different from the first thermoplastic polymer.

In some embodiments, the second bolster comprises a third plurality of three-dimensional filament loops, the third plurality of three-dimensional filament loops composed of a third thermoplastic polymer different from the first and second thermoplastic polymers.

In some embodiments, the second bolster comprises a third plurality of three-dimensional filament loops, the third plurality of three-dimensional filament loops composed of a third thermoplastic polymer different from the first thermoplastic polymer.

In some embodiments, the vehicle seat cushion component further comprises a third bolster comprises a fourth plurality of three-dimensional filament loops, the fourth plurality of three-dimensional filament loops composed of a fourth thermoplastic polymer different from the first thermoplastic polymer.

In some embodiments, the plurality of three-dimensional filament loops includes a plurality of fused connection in which two loops are attached to each other.

In some embodiments, at least a subset of loops in the plurality of three-dimensional filament loops are not parallel or aligned with each other.

In some embodiments, loops in the plurality of three-dimensional filament loops are randomly oriented.

In some embodiments, the thermoplastic polymer is an extruded thermoplastic polymer.

In some embodiments, the thermoplastic polymer includes a component selected from the group consisting of polyolefin, polystyrene-based thermoplastic elastomer, polyester-based thermoplastic elastomer, polyurethane-based thermoplastic elastomer, and polyamide-based thermoplastic elastomer.

In some embodiments, the thermoplastic polymer includes a first linear low-density polyethylene.

In some embodiments, the thermoplastic polymer includes a second linear low-density polyethylene different than the first linear low-density polyethylene.

A seat assembly is described. The seat assembly includes a frame and the cushion according to any of the above techniques, the cushion supported by the frame.

A tool is described. The tool includes: a die defining a series of apertures arranged to extrude material for the stranded mesh material member for the cushion according to any one of claims 87-99, the series of apertures arranged to define the outer perimeter of the member to define the plastic mesh base (e.g., 360), the first bolster and the second bolster.

In some embodiments, the series of apertures are further arranged such that the outer perimeter defines the bolsters.

A method 210 is described. Method 210 includes extruding 212 a first thermoplastic polymer to form a plastic mesh base (e.g., 360) comprising a first plurality of three-dimensional filament loops, the plastic mesh base (e.g., 360) having a first side edge, a second side edge, a front edge, a rear edge, a first face, and a second face; and extruding 214 a second thermoplastic polymer to form a first bolster attached to the plastic mesh base (e.g., 360) at the first edge, the first foamed bolster comprising a second plurality of three-dimensional filament loops, the second thermoplastic polymer different from the first thermoplastic polymer.

Method 210 includes extruding 216 material to form a second bolster attached to the plastic mesh base (e.g., 360) at the second edge.

In some embodiments, the second bolster comprises a third plurality of three-dimensional filament loops, the third plurality of three-dimensional filament loops composed of the second thermoplastic polymer.

In some embodiments, the second bolster comprises a third plurality of three-dimensional filament loops, the third plurality of three-dimensional filament loops composed of a third thermoplastic polymer different from the first thermoplastic polymer.

In some embodiments, the second bolster comprises a third plurality of three-dimensional filament loops, the third plurality of three-dimensional filament loops composed of a third thermoplastic polymer different from the first and second thermoplastic polymers.

In some embodiments, the second bolster comprises a third plurality of three-dimensional filament loops, the third plurality of three-dimensional filament loops composed of a third thermoplastic polymer different from the first thermoplastic polymer.

In some embodiments, the technique includes a third bolster that comprises a fourth plurality of three-dimensional filament loops, the fourth plurality of three-dimensional filament loops composed of a fourth thermoplastic polymer different from the first thermoplastic polymer.

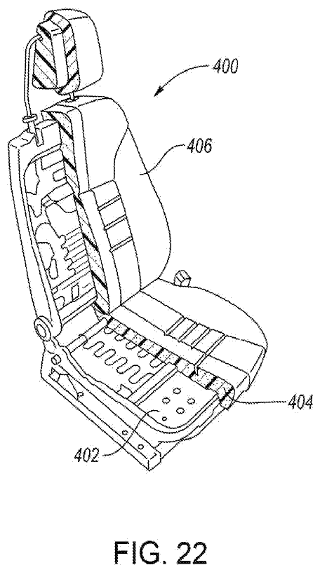

Referring to FIG. 22, a seat assembly 400 is disclosed. In an embodiment, the seat assembly 400 includes a seat frame 402, one or more seat cushions 404, and a trim cover 406. In a refinement, the seat assembly 400 may include further components such as but not limited to a massaging assembly, a ventilation assembly, a heating assembly, and/or a sensor assembly. In a refinement, the seat assembly 400 is a seat for a vehicle such as an automobile, motorcycle, aircraft, watercraft, and/or train.

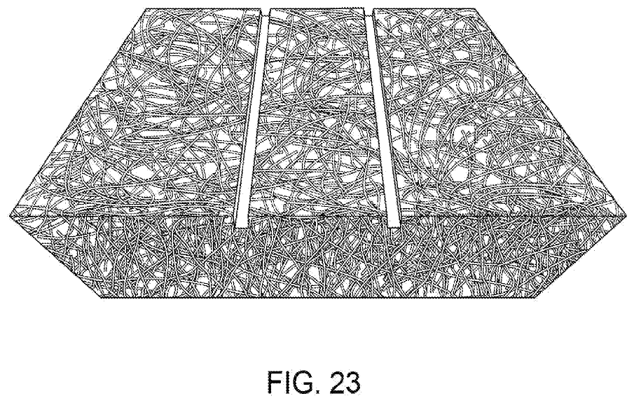

In one or more embodiments, the one or more cushions 404 include a seat bottom and/or seat back. Unlike conventional seat cushions which are generally injection molded foams, a seat cushion of the seat assembly 400 may be a non-foam, a foam free, a foamless, and/or a non-woven mesh cushion 408 of intertwined and/or entangled polymeric strands 410, as shown in FIG. 23. Portions of the various polymeric strands are entangled with portions of other polymeric strands such that the plurality of polymeric strands serves as a single unit, piece, cushion, pillow, pad, or mat. Hereinafter, this disclosure will refer to it as a non-foam cushion 408 or foamless cushion 408. The polymeric strands are any suitable polymeric material such as a thermoplastic polymer (e.g., polyolefins, polyethylene, polypropylene, polystyrene, polycarbonate, polyurethane, and/or polyvinyl chloride).

In a refinement, the foamless cushion 412 includes a first portion/section/region/volume/zone 414 having a first hardness and a second portion/section/region/volume/zone 416 having a second hardness that is different than the first hardness, as shown in FIG. 23. In a refinement, the hardness is determined with equivalent volumes according to ASTM 3574. The first portion may include a first group of intertwined/entangled polymeric strands and the second portion may include a second group of intertwined/entangled polymeric strands. Hereinafter this description will refer to it as portions of the cushion however it likewise could be referred to as sections, regions, volumes, zones of the cushion and/or groups of polymer strands. It should also be understood that although referenced differently, the portions are connected by intertwined or entangled polymeric strains.

In a variation, the first portion 414 is harder than the second portion 416. In another variation, the second portion 416 may be harder than the first portion 414. For example, the first portion 414 may be a bolster region of a seat bottom and be harder than the second portion 416 which may be seat portion.

The foamless cushion 412 includes other portions having different hardness. For instance, the cushion 412 includes a third portion 418 having a third hardness that is different than the second hardness. In a refinement, the third hardness is the same or substantially the same as the first hardness (i.e., within manufacturing tolerance, within 1%, 1.5%, 3%, 5%, or 10%).

In one or more embodiments, the first and second hardnesses may be different by at least 0.5 kPa, or more preferably at least 2 kPa, or even more preferably at least 4 kPa. In a refinement, one portion has a hardness of at least 5 kPa, or more preferably at least 7.5 kPa, or even more preferably at least 10 kPa and another portion has a hardness of no more than 5 kPa, or more preferably no more than 4.5 kPa, or even more preferably no more than 4.0 kPa.

In a refinement, one portion has a hardness of 5 to 15 kPa, or more preferably 7 to 12 kPa, or even more preferably 8 to 10 kPa and another portion may have a hardness of 1 to 5 kPa, or more preferably 2 to 4.5 kPa, or even more preferably 3 to 4 kPa.

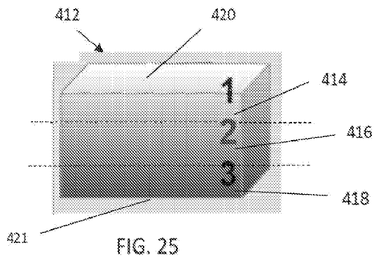

In yet another variation, a foamless cushion 412 has a gradient hardness as illustrated by shading in FIG. 25. The foamless cushion 412 has a first portion 414 with the lowest hardness (e.g., least shaded portion), a second portion 416 with an intermediate hardness (i.e., hardness between that of the first and third portions 414, 416), and a third portion 418 with the highest hardness (e.g., darkest shaded portion). The portions therebetween may continuously increase in hardness as they become further from the first portion 414 and closer to the third portion 416 such that a hardness gradient exists.

In an embodiment, the first portion 414 is be disposed at a first end 420 and the third portion 418 is disposed at a second end 416. In a refinement, the second portion 416 may be centrally located. Alternatively, a harder or softer portion may be arrange centrally and the other of the harder or softer portion may be arranged on the periphery.

In one variation, the first portion 414 may form the top of a seat bottom such that is arranged to be proximate to an occupant whereas the third portion 418 may be arranged such that it is distal to the occupant. This may provide the occupant with the sensation of immediate softness and/or comfort without sacrificing long-term durability and comfort.

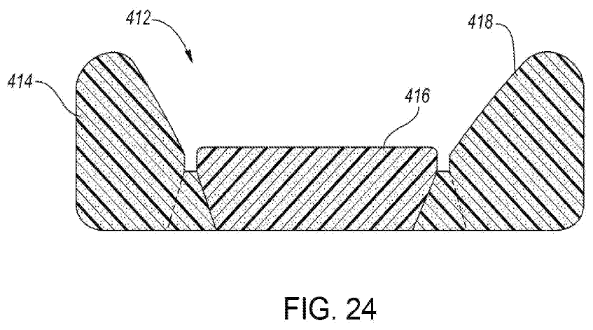

The different portions of the foamless cushion may provide different degrees of hardness by having different attributes or characteristics. For example, the bulk densities of different portions may be different. In a refinement, bulk density is determined according to ISO 845. Any portion described above as having a greater hardness may have greater a density. For example, the bolster region, as shown in FIG. 24, may have a greater density than the central region. In a refinement, the bulk densities may be different by at least 3.0 kg/m³, or more preferably at least 7.0 kg/m³, or even more preferably at least 10 kg/m³. In a variation, the bulk density difference may be 3 to 20 kg/m³, or more preferably 5 to 15 kg/m³, or even more preferably 6 to 12 kg/m³. For example, one portion has a bulk density of no more than 60 kg/m³, or more preferably no more than 55 kg/m³, or even more preferably no more than 50 kg/m³ and a bulk density of at least 30 kg/m³, or more preferably at least 35 kg/m³, or even more preferably at least 40 kg/m³. For example, the one portion may have a density of 60 to 30 kg/m³, or more preferably 55 to 35 kg/m³, or even more preferably 50-40 kg/m³ and another portion may have a density of +3.0 kg/m³, or more preferably at least 7.0 kg/m³, or even more preferably at least 10 kg/m³. For example, another portion may have a density of no more than 57 kg/m³, or more preferably no more than 53 kg/m³, or even more preferably no more than 50 kg/m³. In yet another embodiment, another portion may have a density of at least 33 kg/m³, or more preferably at least 37 kg/m³, or even more preferably at least 40 kg/m³. For example, a one portion may have a density of 60 to 33 kg/m³, or more preferably 60 to 37 kg/m³, or even more preferably 60 to 40 kg/m³ and another portion may have a bulk density of 57 to 30 kg/m³, or more preferably 53 to 30 kg/m³, or even more preferably 50 to 30 kg/m³.

In one more embodiments, each portion has an average strand diameter. The average diameter of a first portion is different than the average diameter of a second portion. The difference may be at least 0.2 mm, or more preferably at least 0.4 mm, or even more preferably 0.6 mm. The difference may be 0.1 to 3 mm, or more preferably 0.3 to 1.8 mm, or even more preferably 0.5 to 1.2 mm. In a refinement, the average diameter of one portion may be at least 1.1 times that an average diameter of another portion, or more preferably at least 1.5 times, or even more preferably at least 2 times larger than the average diameter of another portion. In other words, the average diameter of one portion may be 110%, or more preferably 150%, or even more preferably 200% of the average diameter of another portion. For example, in an embodiment, a portion has an average diameter of at least 1.2 mm, or more preferably at least 1.4 mm, or even more preferably at least 1.6 mm and another portion has an average diameter of no more than 1.2 mm, or more preferably no more than 1.0 mm, or even more preferably no more than 0.8 mm. In a refinement, a portion may have an average diameter of 0.05 to 10 mm, or more preferably 0.1 to 5 mm, or even more preferably 0.5 to 1.2 mm and another portion has an average diameter of 0.8 to 15 mm, or more preferably 1.2 to 13 mm, or even more preferably 1.6 to 10 mm.

In still another embodiment, a third portion 303, as shown in FIGS. 24-25, has a bulk density and/or average diameter that is different than the first portion and/or the second portion. In a refinement, the bulk density and/or average diameter may be the same or substantially the same (i.e., within manufacturing tolerance, within 1%, 1.5%, 3%, 5%, or 10%) as a first portion. In some embodiments, the second portion may be disposed between the first and third portions. In other embodiments, the first portion may have lowest bulk density and/or average diameter, while the third portion has the greatest bulk density and/or average diameter (i.e., the third portion is greater than the second portion and the second portion is greater than the first portion) or vice versa.

In another embodiment, the first, second, and/or third portions may have strands of different shapes such as round, square, triangular, star, or various other shapes. When the shape is not round, the diameter may refer max diameter of a widthwise (as opposed to lengthwise) cross-section of the strand to distinguish the relative size of the various strands. For example, in one embodiment, a first group of strands may be round and a second group of strands may be polygonal (e.g., rectangular).

The seat frame 402 may be made of rigid material such as metal, plastic, wood, or a combination thereof. The seat frame 402 may support the foamless cushion 404, other seat assemblies (e.g., massage assembly, ventilation assembly, electronic assembly, etc.), and/or an occupant. For example, an aluminum seat frame 402 may be used.

In one or more embodiments, the trim cover 406 is disposed over the one or more cushions 404 and/or the seat frame 402. The trim cover 406 is arranged to contact an occupant. For example, the trim cover 406 may be made of leather, faux leather, polyurethane, and/or polyester.

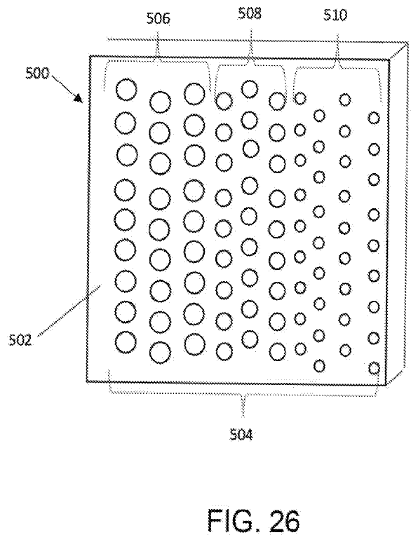

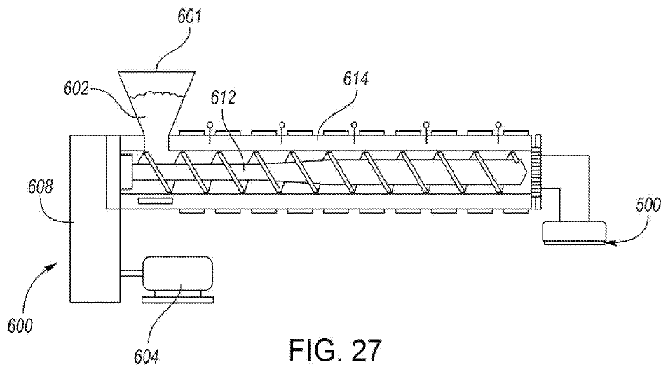

Referring to FIG. 26, a die 500 such as a breaker plate may be used to dispense the polymeric resin as polymeric strands. In a refinement, the die 500 is an interchangeable component of the dispensing system 600, as shown in FIG. 27, such that different dies can be used to provide cushions having different characteristic and attributes (e.g., shapes, hardnesses, bulk densities, average strand diameters). For example, a first die may yield a cushion having a harder bolster region and a softer central seat region, as shown in FIG. 24 and a second die may yield a cushion having a gradient hardness from a first surface to a second surface, as shown in FIG. 25.

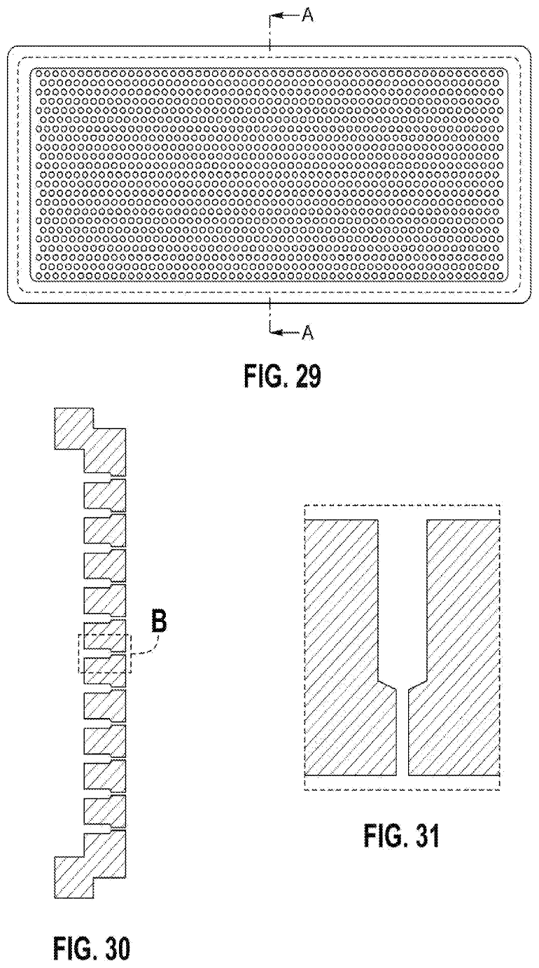

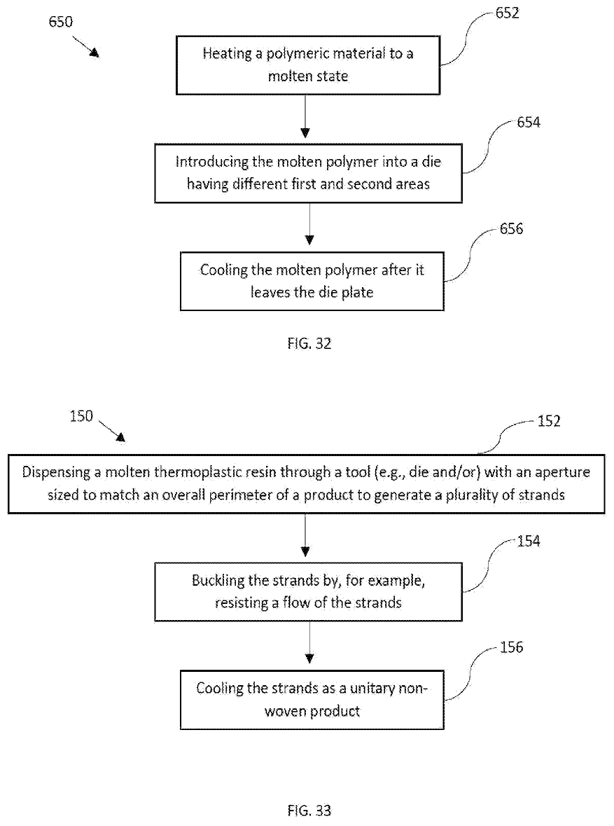

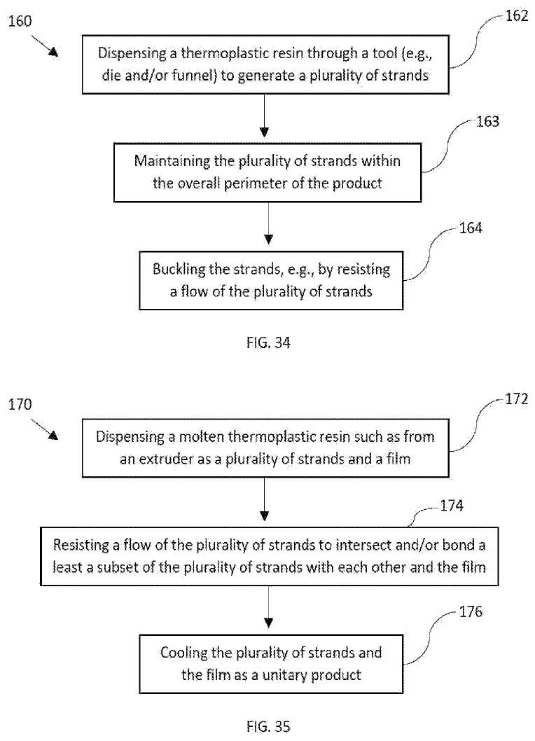

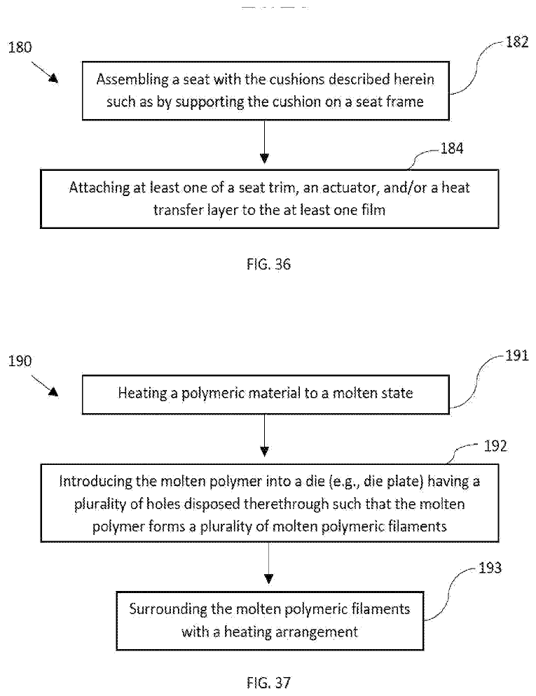

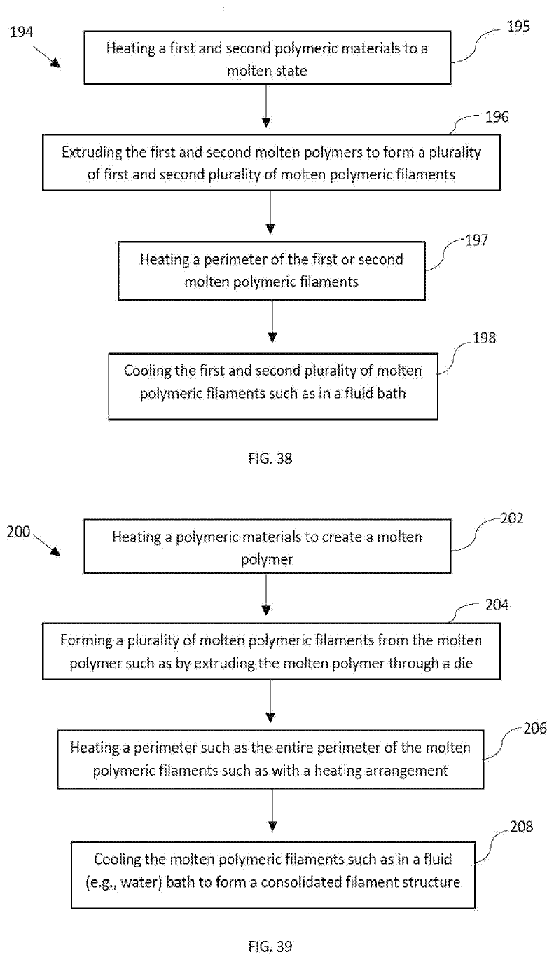

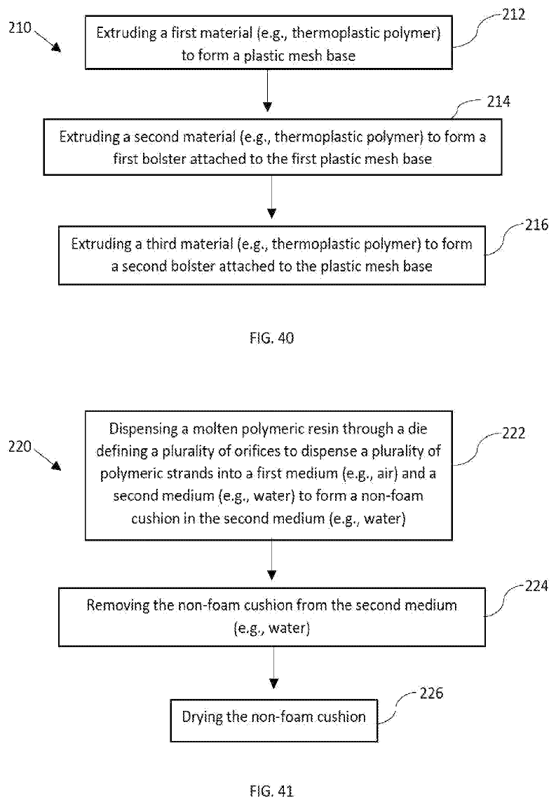

The die 500 includes a solid body 502 which defines a plurality of orifices 504. In one or more embodiment, the plurality of orifices 504 may include at least 50 orifices, or more preferably at least 500 orifices, or even more preferably at least 1000 orifices. For example, FIG. 29 illustrates a die having at least 1200 orifices. FIGS. 30-31 illustrate cross-sectional view of the breaker plate of FIG. 29. As shown, each orifice may be taper from a larger orifice to a smaller orifice which may generate a greater pressure for dispensing the flowable polymeric strand from the die. The dispensing system 600 applies pressure such that the polymeric resin 602 is dispensed through the orifices 504 of the die 500. Accordingly, the size, arrangement, distribution, and density of orifices 504 will affect the characteristic and/or attributes of the cushion such as the overall shape, hardness, bulk density, average strand diameter, and strand shape. In a refinement, the plurality of orifices 504 includes at least a first group of orifices 506 having a different size, distribution, density and/or shape than a second group of orifices 508. In a variation, a third group of orifices 510 has a different size, distribution, density and/or shape than the first and/or second group of orifices.

Each group of orifices has an average diameter and orifice density (i.e., a first group of orifices having a first average diameter and first orifice density, a second group of orifices having a second average diameter and second orifice density, and a third group of orifices having a third average diameter and third orifice density). In a refinement, the first average diameter may be different than the second and/or third average diameter and/or the first orifice density may be different than the second and/or third average density. In a variation, the first and third average diameter and/or orifice densities are the same or substantially the same (i.e., within manufacturing tolerance, within 1%, 1.5%, 3%, 5%, or 10%). In another variation, the first average diameter may be less than the second average diameter and the second average diameter is less than the third average diameter. Alternatively, or in combination, the first orifice density may be less than the second orifice density and the second orifice density may be less than the third orifice density.

In a refinement, the first average diameter is at least 1.2 mm, more preferably at least 1.4 mm, or even more preferably at least 1.6 mm. For example, the first average diameter may be 0.8 to 10 mm, or more preferably 1 to 5 mm, or even more preferably 1.2 to 3 mm. In some embodiments, the first orifice density may be at least 11.5 orifices per square inch, or more preferably at least 13 orifices per square inch, or even more preferably at least 15 orifices per square inch. For example, the first orifice density may be 10 to 20 orifices per square inch, or more preferably 11 to 18 orifices per square inch, or even more preferably 12 to 16 orifices per square inch. Alternatively, the first average diameter may be no more than 1.2 mm, or more preferably no more than 1.0 mm, or even more preferably no more than 0.8 mm. For example, the first average diameter may be 0.05 to 1.2 mm, or more preferably 0.3 to 1.0 mm, or even more preferably 0.7 to 0.9 mm. In some embodiments, the first orifice density may be no more than 11.5 orifices per square inch, or more preferably no more than 10 orifices per square inch, or even more preferably no more than 8 orifices per square inch. For example, the first orifice density may be 1 to 11.5 orifices per square inch, or more preferably 3 to 10 orifices per square inch, or even more preferably 5 to 8 orifices per square inch.

In a refinement, the second average diameter is at least 0.8 mm, more preferably at least 0.9 mm, or even more preferably at least 1.0 mm and no more than 1.6 mm, or more preferably no more than 1.5 mm, or even more preferably no more than 1.4 mm. For example, the second average diameter is 0.8 to 1.6 mm, or more preferably 0.9 to 1.5 mm, or even more preferably 1.0 to 1.4 mm. In some embodiments, the second orifice density is at least 9 orifices per square inch, or more preferably at least 10 orifices per square inch, or even more preferably at least 11 orifices per square inch and no more than 14 orifices per square inch, or more preferably no more than 13 orifices per square inch, or even more preferably 12 orifices per square inch. For example, the second orifice density is 9 to 14 orifices per square inch, or more preferably 10 to 13 orifices per square inch, or even more preferably 11 to 12 orifices per square inch.

In a refinement, the third average diameter is at least 1.2 mm, more preferably at least 1.6 mm, or even more preferably at least 1.8 mm. For example, the third average diameter may be 1.2 to 10 mm, or more preferably 1.6 to 8 mm, or even more preferably 1.8 to 5 mm. In some embodiments, the third orifice density may be at least 11.5 orifices per square inch, or more preferably at least 13 orifices per square inch, or even more preferably at least 15 orifices per square inch. For example, the third orifice density may be 10 to 20 orifices per square inch, or more preferably 11 to 18 orifices per square inch, or even more preferably 12 to 16 orifices per square inch.

In a variation, the orifices may form one or more gradients relative to their distribution (i.e., orifice density) and/or size (e.g., average diameter). The gradient may correspond to the gradients as described above with regards to the cushion. For example, orifices proximate a first end of the die 500 may be larger and continuously decrease in size as they become further from the first end and more proximate a second end where the smallest orifices are located. Alternatively, the orifices at the periphery may be smaller while the central orifices or orifices in the mid-portion are larger. In another example, the first group of orifices proximate a first end of the die 500 may be more concentrated or arranged to have a greater orifice density and continuously decrease concentration or orifice density as they become further from the first end and more proximate a second end where the least concentrated orifices or lowest orifice density occurs. Alternatively, the orifices at the periphery may less concentrated or have a lower orifice density than orifices at the center or mid-portion.

Referring to FIG. 27, the die 500 is arranged in the dispensing system 600. In an embodiment, dispensing system 600 includes an inlet 601 such as a hopper for receiving polymeric resin 602 such as in a solid pelletized form. In a refinement, the polymeric resin 602 is sheared and heated such as by extruder 604 which melts the solid polymeric resin 602 into a flowable form such as a molten polymeric resin 602 prior to dispensing it from the die 500. In an embodiment, the extruder 604 may be driven by a motor 606 and a transmission 608. In a refinement, the extruder 604 includes a screw 612 disposed in a barrel 614. In one or more embodiments, the die 500 is disposed and/or arranged at a terminal end of the extruder 604 such that it can easily be removed and replaced by another die.

Referring to FIG. 8, the flowable molten polymeric resin 131 is dispensed from the die 500 as strands and flows linearly into and through a first medium 135 such as air and then into a second medium 139 such as water. In a refinement, the first and second mediums 135, 139 have different densities such that deflection occur at or proximate the medium interface 137 (i.e., the linear strands change direction). For example, the second medium 139 may have a greater density than the first medium 135. In a variation, the second medium 139 is chilled to the below the melting point and/or glass transition temperature of the polymeric resin. In a refinement, the second medium 139 may also have a greater heat capacity than the first medium 135. The deflection or changes in direction may lead to entanglement and/or the intertwining of the polymeric strands when accompanied by the cooling effect of the second medium 139 the polymeric strands may solidify such that the entangled/intertwining mass is a single piece, component, unit and/or generally holds its shape such as in the form a cushion. In a one or more embodiments, the entangled/intertwined mass of polymeric strands may exhibit elastic properties similar to a foam and/or fabric. In a refinement, the entangled/intertwined mass may be cleaned and/or dried after being removed from the second medium 139. Once hardened the strands may be generally fixed in position relative to one another such that they may become more proximal or distal depending on the pressure exerted upon them but generally don't change positions relative to one another. Accordingly, portions having a greater bulk density and/or larger size may present a greater overall hardness and portions having a lesser bulk density and/or size may present a lesser overall hardness.

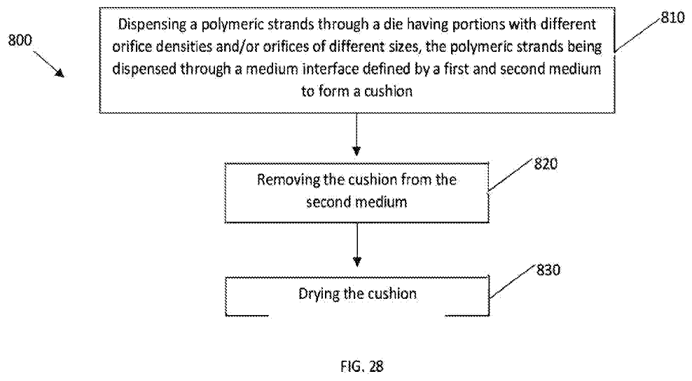

A method 800 of making a seat cushion or pad is disclosed, as shown in FIG. 28. In one or more embodiments, the method 800 includes dispensing a plurality of polymeric strands from a die into and through a medium interface to form a cushion (i.e., step 810), removing the cushion from the second medium (i.e., step 820), and drying the cushion (i.e., step 830). In a refinement, dispensing occurs via an extruder as shown in FIG. 8. The extruder is configured to receive a polymeric resin such as a thermoplastic polymeric resin. In a variation, the extruder includes a hopper for receiving the polymer resin. For example, pellets or beads of the polymeric resin may be loaded in the hopper. The hopper may direct the polymeric resin into a chamber/barrel and a drive such as a screw may be engaged shear the polymeric resin. In a refinement, the chamber/barrel and/or portions thereof are heated. The combination of shear and heat renders the solid pelletized polymeric resin into a molten polymeric material that is flowable. For example, the chamber/barrel is heated to a temperature that exceeds the melting point of the resin.

The molten polymeric strands may be dispensed into a first medium such as air. In a refinement, the strands are dispensed from a die such as a breaker plate having portions with different orifice densities and/or orifice sizes. In a variation, the breaker plate includes a gradient such as an orifice density gradient and/or an orifice size gradient. In a refinement, the breaker plate is an interchangeable component of an extruder such that a first die/breaker plate that is used to make a first plurality of components and exchanged with a second die/breaker plate that is used to make a second plurality of components that are different than the first plurality of components. The die 500 may be arranged such that gravity further directs the polymeric strands in a linear motion into the second medium. In a refinement, the second medium is denser than the first medium. The mediums define a medium interface therebetween. For instances, the first medium may be a gas and the second medium may be a liquid such as water. The difference may result in deflection (e.g., bending) of the polymeric strands at or proximate the medium interface. The random deflection of the various polymeric strands results in entanglement of the plurality of polymeric strands. The intertwined and entangled polymeric strands also harden as they are cooled by the second medium and transition out of their molten state. In a refinement, the hardened intertwined/entangled mass of polymeric strands may form a non-foam/foamless cushion. In a variation, the mass (e.g., cushion) is removed from the second medium and dried. Given the different characteristics of portions of the die the cushion may have different attributes such as harder and softer regions. In a refinement, the different hardnesses are the result of different bulk densities and/or strand diameters.

A foamless seat cushion is described. The foamless seat cushion includes a plurality of intertwined polymeric strands having a first group of intertwined polymeric strands with a first hardness, and a second group of intertwined polymeric strands having a second hardness that is different than the first hardness, wherein the first and second groups of intertwined polymeric strands are connected.

In some embodiments, the first group of intertwined polymeric strands has a first average diameter, and the second group of intertwined polymer strands has a second average diameter that is different than the first average diameter.

In some embodiments, the first group of intertwined polymeric strands defines a first bulk density, and the second group of intertwined polymeric strands has a second bulk density that is different than the first density.

In some embodiments, the first hardness is less than the second hardness and the first hardness is no more than 5 kPa.

In some embodiments, the second hardness is at least 5 kPa.

In some embodiments, the foamless seat cushion further comprises a third group of intertwined polymeric strands from the plurality of intertwined polymeric strands having a third hardness, the second group of intertwined polymeric strands being disposed between the first and third groups of intertwined polymeric strands such that the first hardness is less than the second hardness and the third hardness is greater than the second hardness.

In some embodiments, the plurality of intertwined polymeric strands from a hardness gradient from a first region of the cushion to a second region of the cushion.

A vehicle seat assembly (e.g., 400) is described. The vehicle set assembly (e.g., 400) comprises a seat frame (e.g., 402) supporting the foamless cushion of any of the preceding techniques.

A die such as breaker plate (e.g., 500) is described. The die (e.g., breaker plate 500) includes a solid body defining a plurality of orifices, the plurality of orifices (e.g., 504) having a first group (e.g., 506) of orifices and a second group (e.g., 508) of orifices, the first group (e.g., 506) of orifices being present at a first orifice density and having a first average diameter, the second group (e.g., 508) of orifices being present at a second orifice density and having a second average diameter wherein the first orifice density different than the second orifice density and/or the first average diameter is different than the second average diameter.

In some embodiments, the first orifice density is different than the second orifice density.

In some embodiments, the first average diameter is different than the second average diameter.

In some embodiments, the first orifice density is no more than 11.5 orifices per square inch.

In some embodiments, the first and second average diameters are different by at least 0.4.

In some embodiments, the first and second orifice density is different by at least 3.0 kg/m³.

A system for dispensing a polymeric resin is described. The system comprises an extruder with the breaker plate (e.g., 500) of any of the above techniques disposed therein such that during operation the extruder extrudes strands of the polymeric resin through the plurality of orifices (e.g., 504) during operation.

A method 220 of making a seat pad is described. Method 220 includes dispensing 222 a molten polymeric resin through a die (e.g., 500) defining a plurality of orifices (e.g., 504) to dispense a plurality of polymeric strands into a medium interface defined by a first medium and a second medium such that at least a portion of polymeric strands are deflected, intertwines, and harden to form a non-foam cushion in the second medium.

Method 220 includes removing 224 the non-foam cushion from the second medium. Method 220 includes drying 226 the non-foam cushion. The plurality of orifices includes (i) a first group (e.g., 506) of orifices arranged at a first density and defining a first average diameter and (ii) a second group (e.g., 508) of orifices arranged at a second density and defining a second average diameter, the first density being different than the second density and/or the first average diameter being different than the second average diameter such the non-foam cushion has a first region with a first hardness and a second region with a second hardness that is different than the first hardness.

In some embodiments, the plurality of orifices (e.g., 504) is defined by an interchangeable breaker plate.

In some embodiments, the plurality of orifices (e.g., 504) is arranged to form a size and/or distribution gradient such that the non-foam cushion has a gradient hardness.

In some embodiments, the plurality of orifices (e.g., 504) includes a third group (e.g., 510) of orifices such that the non-foam cushion has a third region having a third hardness that is greater than the second hardness which is greater than the first hardness, the second region being disposed between the first and third regions.

In some embodiments, the plurality of orifices (e.g., 504) includes a third group of orifices such that the non-foam cushion has a third region having a third hardness that is different than the second hardness and within 10% of the first hardness, the second region being disposed between the first and third regions.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

Clause 1. A method for producing a vehicle interior component, comprising: heating a polymeric material to a molten state, such that it becomes a molten polymer; introducing the molten polymer into a die plate having a first area containing a plurality of first holes therethrough and a second area containing a plurality of second holes therethrough, the first holes together defining a first open space per unit area in the first area and the second holes together defining a second open space per unit area in the second area, and wherein the first open space per unit area is greater than the second open space per unit area; and cooling the molten polymer after it leaves the die plate.

Clause 2. The method of claim 1 or any of the subsequent clauses, wherein there are more of the first holes per unit area in the first area than the second holes per unit area in the second area.

Clause 3. The method of any of the preceding or subsequent clauses, wherein the first holes have a larger diameter than the second holes.

Clause 4. The method of any of the preceding or subsequent clauses, wherein cooling the polymer after it leaves the die plate produces a cushion blank, the method further comprising masking a portion of the die plate with a template having a predefined outline portion such that the cushion blank has a cross section that is defined by the predefined outline portion.

Clause 5. The method of any of the preceding or subsequent clauses, wherein the second area includes a location that corresponds to a location of an occupant sensor in the cushion blank.

Clause 6. The method of any of the preceding or subsequent clauses, wherein the die plate includes two of the first areas, each being positioned in a location that corresponds to a respective bolster area of the cushion blank.

Clause 7. The method of claim of any of the preceding or subsequent clauses, wherein the die plate includes a third area containing a plurality of third holes therethrough, the third holes together defining a third open space per unit area in the third area, and wherein the third open space per unit area is less than the second open space per unit area.

Clause 8. A vehicle interior component formed by the method of any of the preceding or subsequent clauses.

Clause 9. A method for producing a vehicle interior component, comprising: heating a polymeric material to a molten state, such that it becomes a molten polymer; introducing the molten polymer into a die plate including a first area having an open portion and a closed portion and a second area having an open portion and a closed portion, and wherein a ratio of the open portion of the first area to the first area is greater than a ratio of the open portion of the second area to the second area; and cooling the molten polymer after it leaves the die plate.

Clause 10. The method of any of the prior or subsequent clauses, wherein the first area includes a plurality of first holes defining the open portion of the first area, and the second area includes a plurality of second holes defining the open portion of the second area, and wherein there are more of the first holes per unit area in the first area than the second holes per unit area in the second area.

Clause 11. The method of any of the prior or subsequent clauses, wherein the first area includes a plurality of first holes defining the open portion of the first area, and the second area includes a plurality of second holes defining the open portion of the second area, and wherein the first holes have a larger diameter than the second holes.

Clause 12. The method of any of the prior or subsequent clauses, wherein the vehicle interior component includes a cushion blank having a cross section, the method further comprising masking a portion of the die plate with a template having an outline defining the cross section of the cushion blank.

Clause 13. The method of any of the prior or subsequent clauses, wherein the die plate includes a plurality of the first areas, each being positioned in a location that corresponds to a respective bolster area of the cushion blank.

Clause 14. The method of any of the prior or subsequent clauses, wherein the second area includes a location configured to receive an occupant sensor in the cushion blank.

Clause 15. The method of any of the prior or subsequent clauses, wherein the die plate further includes a third area having an open portion and a closed portion, and wherein the ratio of the open portion of the second area to the second area is greater than a ratio of the open portion of the third area to the third area.

Clause 16. A die-plate arrangement usable to produce a vehicle interior component, comprising: a plate including a first area containing a plurality of first holes therethrough and a second area containing a plurality of second holes therethrough, the first holes together defining a first open portion in the first area and the second holes together defining a second open portion in the second area, and wherein a ratio of the first open portion to the first area is greater than a ratio of the second open portion to the second area.

Clause 17. The die-plate arrangement of any of the preceding or subsequent clauses, wherein there are more of the first holes per unit area in the first area than the second holes per unit area in the second area.

Clause 18. The die-plate arrangement of any of the preceding or subsequent clauses, wherein the first holes have a larger diameter than the second holes.

Clause 19. The die-plate arrangement of any of the preceding or subsequent clauses, further comprising a template configured to cover at least a portion of the first holes, at least a portion of the second holes, or at least a portion of the first holes and the second holes, the template having a predefined outline portion defining a cross section of a portion of the vehicle interior component.

Clause 20. The die-plate arrangement of any of the preceding or subsequent clauses, wherein the vehicle interior component is a seat cushion, and the plate includes two of the first areas, each being positioned in a location that corresponds to a respective bolster area of the seat cushion.

Clause 21. A method of manufacturing a product, comprising: dispensing, through a tool with an aperture sized to match an overall perimeter of a product, a molten thermoplastic resin, the tool generating a plurality of strands through the tool aperture while maintaining the plurality of strands within the overall perimeter of the product; and buckling the strands by resisting a flow of the plurality of strands, the buckled strands intersecting as a unitary non-woven body in a shape of the overall perimeter of the product.

Clause 22. The method of any of the preceding or subsequent clauses, further comprising cooling the plurality of strands as a unitary non-woven product.

Clause 23. The method of any of the preceding or subsequent clauses further comprising: dispensing the molten thermoplastic resin from a plurality of nozzles, the plurality of nozzles, collectively, comprising an area greater than the area of the aperture; and closing a subset of the plurality of nozzles outside the area of the aperture.

Clause 24. The method of any of the preceding or subsequent clauses, further comprising providing a plate as the tool.

Clause 25. The method of any of the preceding or subsequent clauses, further comprising cooling the tool.

Clause 26. The method of any of the preceding or subsequent clauses, further comprising providing a mold with the aperture as the tool.

Clause 27. The method of any of the preceding or subsequent clauses, further comprising providing cooling passages through the mold to cool the unitary non-woven product.

Clause 28. The method of any of the preceding or subsequent clauses, further comprising placing the mold in a cooling fluid, the cooling fluid cooling the unitary non-woven product.

Clause 29. A product manufactured according to a method comprising: dispensing, through a tool with an aperture sized to match an overall perimeter of a product, a molten thermoplastic resin, the tool generating a plurality of strands through the tool aperture while maintaining the plurality of strands within the overall perimeter of the product; and buckling the strands by resisting a flow of the plurality of strands, the buckled strands intersecting as a unitary non-woven body in a shape of the overall perimeter of the product.

Clause 30. The product of any of the preceding or subsequent clauses, wherein the product further comprises a unitary non-woven cushion.

Clause 31. The product of any of the preceding or subsequent clauses, wherein the product further comprises a concave contoured perimeter.

Clause 32. A tool comprising: a tool body with a through aperture, the through aperture sized to match an overall perimeter of a cushion, the through aperture configured to receive a molten thermoplastic resin as a plurality of dispensed strands; and the tool through aperture configured to maintain the plurality of dispensed strands within the overall perimeter of the cushion.

Clause 33. The tool of any of the preceding or subsequent clauses, wherein the through aperture is shaped as a seat cushion, the through aperture configured to form a unitary non-woven cushion.

Clause 34. The tool of any of the preceding or subsequent clauses, wherein the through aperture is shaped with curvature, the through aperture configured to form a unitary non-woven cushion with curvature.

Clause 35. The tool of any of the preceding or subsequent clauses, wherein the through aperture is provided with a plurality of curvatures of at least twelve millimeters radii.

Clause 36. The tool of any of the preceding or subsequent clauses, wherein the through aperture is formed with a convex perimeter to form a concave surface on the cushion.

Clause 37. A system to manufacture a cushion, comprising: a dispenser of molten thermoplastic resin; and the tool of any of the preceding or subsequent clauses oriented relative to the dispenser to receive the molten thermoplastic resin.

Clause 38. The system of any of the preceding or subsequent clauses, further comprising a fluid chamber to receive the molten thermoplastic resin to resist a flow of the plurality of dispensed strands to buckle the strands to intersect as a unitary non-woven body in a shape of the overall perimeter of the cushion.

Clause 39. The system of any of the preceding or subsequent clauses, wherein the tool is oriented within the fluid chamber to cool the plurality of dispensed strands as a unitary non-woven cushion.

Clause 40. The system of any of the preceding or subsequent clauses, wherein cooling passages are formed through the tool to cool the plurality of dispensed strands as the unitary non-woven cushion.

Clause 41. A method comprising: dispensing a molten thermoplastic resin as a plurality of strands and at least one film; and resisting a flow of the dispensed plurality of strands, the resisting expanding the plurality of strands by intersecting and bonding at least a subset of the plurality of strands with each other and the at least one film as a unitary body.

Clause 42. The method of any of the preceding or subsequent clauses, further comprising cooling the plurality of strands and the at least one film as a unitary product.

Clause 43. The method of any of the preceding or subsequent clauses, further comprising: cooling the plurality of strands and the at least one film with a fluid, wherein the flow of the plurality of strands is resisted by the fluid.

Clause 44. The method of any of the preceding or subsequent clauses, further comprising cooling the plurality of strands in a fluid chamber.

Clause 45. The method of any of the preceding or subsequent clauses, further comprising dispensing the at least one film on an exterior surface of the unitary body.

Clause 46. The method of any of the preceding or subsequent clauses, further comprising dispensing the at least one film between at least two subsets of the plurality of strands.

Clause 47. The method of any of the preceding or subsequent clauses, further comprising forming an aperture through the at least one film.

Clause 48. The method of any of the preceding or subsequent clauses, wherein dispensing further comprises: dispensing the plurality of strands through a plurality of apertures in a tool; and dispensing the at least one film through at least one slit in the tool.

Clause 49. The method of any of the preceding or subsequent clauses, further comprising: removing the tool from an extruder; installing a second tool to the extruder; dispensing the molten thermoplastic resin as a second plurality of strands and a second film through the second tool; and resisting a flow of the dispensed second plurality of strands, the resisting expanding the second plurality of strands by intersecting at least a subset of the second plurality of strands with each other and the second film as a second unitary body that is different from the first unitary body.

Clause 50. The method of any of the preceding or subsequent clauses, further comprising assembling a seat with a cushion formed by the method.

Clause 51. A product formed by the method of any of the preceding or subsequent clauses.

Clause 52. A product formed by a method comprising: dispensing a molten thermoplastic resin as a plurality of strands and at least one film; and resisting a flow of the dispensed plurality of strands, the resisting expanding the plurality of strands by intersecting at least a subset of the plurality of strands with each other and the at least one film as a unitary body.

Clause 53. The product formed by the method of any of the preceding or subsequent clauses, further comprising: forming the at least one film on an exterior surface of the unitary body.

Clause 54. The product formed by the method of any of the preceding or subsequent clauses, further comprising: forming the at least one film as an impermeable film between at least two subsets of the plurality of strands.

Clause 55. The product formed by the method of any of the preceding or subsequent clauses, further comprising: forming an aperture through the at least one film.

Clause 56. A seat assembly manufactured by a method comprising: assembling a seat with a cushion formed by the method of any of the preceding or subsequent clauses.

Clause 57. The seat assembly manufactured by the method of any of the preceding or subsequent clauses, further comprising: attaching at least one of a seat trim, an actuator, and/or a heat transfer layer to the at least one film.

Clause 58. A product comprising: an expanded mesh of a plurality of interconnected thermoplastic strands; and at least one thermoplastic film integrally bonded to at least one subset of the plurality of strands as a unitary body.

Clause 59. The product of any of the preceding or subsequent clauses, wherein the at least one film is oriented on an exterior surface of the unitary body.

Clause 60. The product of any of the preceding or subsequent clauses, wherein the at least one film is impermeable.

Clause 61. The product of any of the preceding or subsequent clauses, wherein the at least one film is oriented between at least two subsets of the plurality of strands.

Clause 62. The product of any of any of the preceding or subsequent clauses, wherein an aperture extends through the at least one film.

Clause 63. A seat assembly comprising the product of any of the preceding or subsequent clauses, as a seat cushion.

Clause 64. The seat assembly of any of the preceding or subsequent clauses, further comprising at least one of a seat trim, an actuator, and/or a heat transfer layer attached to the at least one film.

Clause 65. A tool comprising a body with a plurality of apertures formed through the body and at least one slit formed through the body to dispense a molten thermoplastic resin through the plurality of apertures and the at least one slit.

Clause 66. A system comprising: an extruder of molten thermoplastic resin; and the tool of any of the preceding or subsequent clauses mounted to the extruder to dispense the molten thermoplastic resin through the tool as a plurality of strands and at least one film.

Clause 67. A method for producing a vehicle interior component, comprising: heating a polymeric material to a molten state, such that it becomes a molten polymer; introducing the molten polymer into a die plate having a plurality of holes disposed therethrough such that the molten polymer moves through the holes and forms a plurality of molten polymeric filaments; surrounding the molten polymeric filaments with a heating arrangement operable to apply heat to the molten polymeric filaments; and introducing the molten polymeric filaments into a bath to cool the molten polymeric filaments to form a consolidated filament structure.

Clause 68. The method of any of the preceding or subsequent clauses, wherein the heating arrangement comprises a rectangular heating structure to surround the molten polymeric filaments as the molten polymeric filaments leave the die plate.

Clause 69. The method of any of the preceding or subsequent clauses, wherein the die plate includes a plurality of sides, and the heating arrangement is attached to each of the sides of the die plate.

Clause 70. The method of any of the preceding or subsequent clauses, wherein the heating arrangement is configured to control an ambient temperature around the molten polymeric filaments to a temperature of 60° C.-140° C.

Clause 71. The method of any of the preceding or subsequent clauses, wherein the heating arrangement is positioned at least 100 mm-150 mm from the molten polymeric filaments.

Clause 72. The method of any of the preceding or subsequent clauses, wherein the molten polymeric filaments include an outer portion disposed toward an outside edge of the die plate, and an inner portion disposed inward from the outer portion, and the heating arrangement is configured to heat the outer portion such that bonding between the molten polymeric filaments of the outer portion is greater than bonding between the molten polymeric filaments of the inner portion.

Clause 73. The method of any of the preceding or subsequent clauses, wherein the molten polymer is a first molten polymer comprising a first material and the molten polymeric filaments are first molten polymeric filaments, and the method further comprises introducing a second molten polymer comprising a second material into the die plate such that the second molten polymer moves through the holes in the die plate and forms a plurality of second molten polymeric filaments.

Clause 74. The method of any of the preceding or subsequent clauses, wherein the first molten polymer is introduced into the die plate toward an outside edge of the die plate, and the second molten polymer is introduced into the die plate inward from the first molten polymer such that the first molten polymeric filaments at least partially surround the second molten polymeric filaments.

Clause 75. A vehicle interior component formed by the method of any of the preceding or subsequent clauses.

Clause 76. A method for producing a vehicle interior component, comprising: heating a first polymeric material to a molten state to create a first molten polymer; extruding the first molten polymer to form a plurality of first molten polymeric filaments; heating an entire perimeter of the first molten polymeric filaments; and cooling the first molten polymeric filaments in a fluid bath to create a consolidated filament structure.

Clause 77. The method of any of the preceding or subsequent clauses, wherein the first molten polymer comprises a first material, and the method further comprises extruding a second molten polymer comprising a second material to form a plurality of second molten polymeric filaments.

Clause 78. The method of any of the preceding or subsequent clauses, wherein the first molten polymer and second molten polymer are extruded such that the first molten polymeric filaments at least partially surround the second molten polymeric filaments.

Clause 79. The method of any of the preceding or subsequent clauses, wherein heating the entire perimeter of the first molten polymeric filaments comprises heating the first molten polymeric filaments on four sides of the first molten polymeric filaments.

Clause 80. The method of any of the preceding or subsequent clauses, wherein heating the entire perimeter of the first molten polymeric filaments comprises heating the first molten polymeric filaments to a temperature of 60° C.-140° C.

Clause 81. The method of any of claims of any of the preceding or subsequent clauses, wherein the entire perimeter of the first molten polymeric filaments is heated such that bonding between the first molten polymeric filaments is greater than bonding between the second molten polymeric filaments.

Clause 82. A vehicle interior component formed by the method of any of the preceding or subsequent clauses.

Clause 83. A method for producing a vehicle interior component, comprising: heating a polymeric material to create a molten polymer; forming a plurality of molten polymeric filaments from the molten polymer by extruding the molten polymer through a die plate; heating an entire perimeter of the molten polymeric filaments with a heating arrangement; and cooling the molten polymeric filaments in a fluid bath to form a consolidated filament structure.

Clause 84. The method of any of the preceding or subsequent clauses, wherein the heating arrangement is attached to the die plate.

Clause 85. The method of any of the preceding or subsequent clauses, wherein the molten polymer is a first molten polymer comprising a first material and the molten polymeric filaments are first molten polymeric filaments, and the method further comprises introducing a second molten polymer comprising a second material into the die plate such that the second molten polymer moves through the die plate and forms a plurality of second molten polymeric filaments.

Clause 86. The method of any of the preceding or subsequent clauses, wherein the first molten polymer is introduced into the die plate toward an outside edge of the die plate, and the second molten polymer is introduced into the die plate inward from the first molten polymer such that the first molten polymeric filaments at least partially surround the second molten polymeric filaments.

Clause 87. A vehicle seat cushion component comprising: a plastic mesh base, the plastic mesh base comprising a first plurality of three-dimensional filament loops, the first plurality of three-dimensional filament loops composed of a first thermoplastic polymer, the plastic mesh base having a first side edge, a second side edge, a front edge, a rear edge, a first face, and a second face; a first bolster attached to the plastic mesh base at the first edge, the first foamed bolster comprising a second plurality of three-dimensional filament loops, the second plurality of three-dimensional filament loops composed of a second thermoplastic polymer different from the first thermoplastic polymer; and a second bolster attached to the plastic mesh base at the second edge.

Clause 88. The vehicle seat cushion component of any of the preceding or subsequent clauses, wherein the second bolster comprises a third plurality of three-dimensional filament loops, the third plurality of three-dimensional filament loops composed of the second thermoplastic polymer.

Clause 89. The vehicle seat cushion component of any of the preceding or subsequent clauses, wherein the second bolster comprises a third plurality of three-dimensional filament loops, the third plurality of three-dimensional filament loops composed of a third thermoplastic polymer different from the first thermoplastic polymer.

Clause 90. The vehicle seat cushion component of any of the preceding or subsequent clauses, wherein the second bolster comprises a third plurality of three-dimensional filament loops, the third plurality of three-dimensional filament loops composed of a third thermoplastic polymer different from the first and second thermoplastic polymers.

Clause 91. The vehicle seat cushion component of any of the preceding or subsequent clauses, wherein the second bolster comprises a third plurality of three-dimensional filament loops, the third plurality of three-dimensional filament loops composed of a third thermoplastic polymer different from the first thermoplastic polymer.

Clause 92. The vehicle seat cushion component of any of the preceding or subsequent clauses, further comprising a third bolster comprises a fourth plurality of three-dimensional filament loops, the fourth plurality of three-dimensional filament loops composed of a fourth thermoplastic polymer different from the first thermoplastic polymer.

Clause 93. The vehicle seat cushion component of any of the preceding or subsequent clauses, wherein the plurality of three-dimensional filament loops includes a plurality of fused connection in which two loops are attached to each other.

Clause 94. The vehicle seat cushion component of any of the preceding or subsequent clauses, wherein at least a subset of loops in the plurality of three-dimensional filament loops are not parallel or aligned with each other.

Clause 95. The vehicle seat cushion component of any of the preceding or subsequent clauses, wherein loops in the plurality of three-dimensional filament loops are randomly oriented.

Clause 96. The vehicle seat cushion component of any of the preceding or subsequent clauses, wherein the thermoplastic polymer is an extruded thermoplastic polymer.

Clause 97. The vehicle seat cushion component of any of the preceding or subsequent clauses, wherein the thermoplastic polymer includes a component selected from the group consisting of polyolefin, polystyrene-based thermoplastic elastomer, polyester-based thermoplastic elastomer, polyurethane-based thermoplastic elastomer, and polyamide-based thermoplastic elastomer.

Clause 98. The vehicle seat cushion component of any of the preceding or subsequent clauses, wherein the thermoplastic polymer includes a first linear low-density polyethylene.

Clause 99. The vehicle seat cushion component of any of the preceding or subsequent clauses, wherein the thermoplastic polymer includes a second linear low-density polyethylene different than the first linear low-density polyethylene.

Clause 100. A seat assembly comprising: a frame; and the cushion according to any of the preceding or subsequent clauses, the cushion supported by the frame.

Clause 101. A tool comprising: a die defining a series of apertures arranged to extrude material for the stranded mesh material member for the cushion according to any of the preceding or subsequent clauses, the series of apertures arranged to define the outer perimeter of the member to define the plastic mesh base, the first bolster and the second bolster.

Clause 102. The tool of any of the preceding or subsequent clauses, wherein the series of apertures are further arranged such that the outer perimeter defines the bolsters.

Clause 103. A method comprising: extruding a first thermoplastic polymer to form a plastic mesh base comprising a first plurality of three-dimensional filament loops, the plastic mesh base having a first side edge, a second side edge, a front edge, a rear edge, a first face, and a second face; and extruding a second a thermoplastic polymer to form a first bolster attached to the plastic mesh base at the first edge, the first foamed bolster comprising a second plurality of three-dimensional filament loops, the second thermoplastic polymer different from the first thermoplastic polymer; and extruding material to form a second bolster attached to the plastic mesh base at the second edge.

Clause 104. The method of any of the preceding or subsequent clauses, wherein the second bolster comprises a third plurality of three-dimensional filament loops, the third plurality of three-dimensional filament loops composed of the second thermoplastic polymer.

Clause 105. The method of any of the preceding or subsequent clauses, wherein the second bolster comprises a third plurality of three-dimensional filament loops, the third plurality of three-dimensional filament loops composed of a third thermoplastic polymer different from the first thermoplastic polymer.

Clause 106. The method of any of the preceding or subsequent clauses, wherein the second bolster comprises a third plurality of three-dimensional filament loops, the third plurality of three-dimensional filament loops composed of a third thermoplastic polymer different from the first and second thermoplastic polymers.

Clause 107. The method of any of the preceding or subsequent clauses, wherein the second bolster comprises a third plurality of three-dimensional filament loops, the third plurality of three-dimensional filament loops composed of a third thermoplastic polymer different from the first thermoplastic polymer.

Clause 108. The method of any of the preceding or subsequent clauses, further comprising a third bolster comprises a fourth plurality of three-dimensional filament loops, the fourth plurality of three-dimensional filament loops composed of a fourth thermoplastic polymer different from the first thermoplastic polymer.

Clause 109. A foamless seat cushion comprising: a plurality of intertwined polymeric strands having a first group of intertwined polymeric strands with a first hardness, and a second group of intertwined polymeric strands having a second hardness that is different than the first hardness, wherein the first and second groups of intertwined polymeric strands are connected.

Clause 110. The foamless seat cushion of any of the preceding or subsequent clauses, wherein the first group of intertwined polymeric strands has a first average diameter, and the second group of intertwined polymer strands has a second average diameter that is different than the first average diameter.

Clause 111. The foamless seat cushion of any of the preceding or subsequent clauses, wherein the first group of intertwined polymeric strands defines a first bulk density, and the second group of intertwined polymeric strands has a second bulk density that is different than the first density.

Clause 112. The foamless seat cushion of any of the preceding or subsequent clauses, wherein the first hardness is less than the second hardness and the first hardness is no more than 5 kPa.

Clause 113. The foamless seat cushion of any of the preceding or subsequent clauses, wherein the second hardness is at least 5 kPa.

Clause 114. The foamless seat cushion of any of the preceding or subsequent clauses, further comprising a third group of intertwined polymeric strands from the plurality of intertwined polymeric strands having a third hardness, the second group of intertwined polymeric strands being disposed between the first and third groups of intertwined polymeric strands such that the first hardness is less than the second hardness and the third hardness is greater than the second hardness.

Clause 115. The foamless seat cushion of any of the preceding or subsequent clauses, wherein the plurality of intertwined polymeric strands from a hardness gradient from a first region of the cushion to a second region of the cushion.

Clause 116. A vehicle seat assembly comprising a seat frame supporting the foamless cushion of any of the preceding or subsequent clauses.

Clause 117. A breaker plate comprising: a solid body defining a plurality of orifices, the plurality of orifices having a first group of orifices and a second group of orifices, the first group of orifices being present at a first orifice density and having a first average diameter, the second group of orifices being present at a second orifice density and having a second average diameter wherein the first orifice density different than the second orifice density and/or the first average diameter is different than the second average diameter.

Clause 118. The breaker plate of any of the preceding or subsequent clauses, wherein the first orifice density is different than the second orifice density.

Clause 119. The breaker plate of any of the preceding or subsequent clauses, wherein the first average diameter is different than the second average diameter.

Clause 120. The breaker plate of any of the preceding or subsequent clauses, wherein the first orifice density is no more than 11.5 orifices per square inch.

Clause 121. The breaker plate of any of the preceding or subsequent clauses, wherein the first and second average diameters are different by at least 0.4.

Clause 122. The breaker plate of any of the preceding or subsequent clauses, wherein the first and second orifice density is different by at least 3.0 kg/m³.

Clause 123. A system for dispensing a polymeric resin comprising an extruder with the breaker plate of any of the preceding or subsequent clauses disposed therein such that during operation the extruder extrudes strands of the polymeric resin through the plurality of orifices during operation.

Clause 124. A method of making a seat pad comprising: dispensing a molten polymeric resin through a die defining a plurality of orifices to dispense a plurality of polymeric strands into a medium interface defined by a first medium and a second medium such that at least a portion of polymeric strands are deflected, intertwines, and harden to form a non-foam cushion in the second medium; removing the non-foam cushion from the second medium; and drying the non-foam cushion, wherein the plurality of orifices includes (i) a first group of orifices arranged at a first density and defining a first average diameter and (ii) a second group of orifices arranged at a second density and defining a second average diameter, the first density being different than the second density and/or the first average diameter being different than the second average diameter such the non-foam cushion has a first region with a first hardness and a second region with a second hardness that is different than the first hardness.

Clause 125. The method of any of the preceding or subsequent clauses, wherein the plurality of orifices is defined by an interchangeable breaker plate.

Clause 126. The method of any of the preceding or subsequent clauses, wherein the plurality of orifices is arranged to form a size and/or distribution gradient such that the non-foam cushion has a gradient hardness.

Clause 127. The method of any of the preceding or subsequent clauses, wherein the plurality of orifices includes a third group of orifices such that the non-foam cushion has a third region having a third hardness that is greater than the second hardness which is greater than the first hardness, the second region being disposed between the first and third regions.

Clause 128. The method of any of the preceding or subsequent clauses, wherein the plurality of orifices includes a third group of orifices such that the non-foam cushion has a third region having a third hardness that is different than the second hardness and within 10% of the first hardness, the second region being disposed between the first and third regions.

Clause 129. A cushion such as for a vehicular seat comprising a (e.g., nonwoven) mesh body. The mesh body includes a plurality of interconnected polymeric filaments, (i) comprising a first subset of polymeric filaments and a second subset of polymeric filaments that is different (e.g., a different composition, hardness, density, shape, size and/or thickness) than the first subset of polymeric filaments; and/or (ii) at least a portion of the interconnected polymeric filaments is bonded to a polymeric film.

Clause 130. The cushion of any of the preceding or subsequent clauses, wherein the first and second subsets are interconnected.

Clause 131. The cushion of any of the preceding or subsequent clauses, wherein (a) the first subset has a first hardness and the second subset has a second hardness that is different than the first hardness, (b) the first subset has a first density and the second subset has a second density different than the first density, (c) the first subset has a first filament size (e.g., chain length/molecular weight/average diameter) and the second subset has a second filament size (e.g., chain length/molecular weight/average diameter), and/or (d) the first subset is formed from a first polymeric material (e.g., polyethylene) and the second subset is formed from a second polymeric material (e.g., polypropylene, polystyrene, polycarbonate, or polyvinyl chloride) that is different than the first polymeric material.

Clause 132. The cushion of any of the preceding or subsequent clauses, wherein the first size is a first average (e.g., larger/thicker) diameter, and the second size is a second average (e.g., smaller/thinner) diameter.

Clause 133. The cushion of any of the preceding or subsequent clauses, wherein the mesh body has a contoured profile.

Clause 134. The cushion of any of the preceding or subsequent clauses, wherein the hardness is a bulk hardness.

Clause 135. The cushion of any of the preceding or subsequent clauses, wherein the cushion is foamless.

Clause 136. The cushion of any of the preceding or subsequent clauses, wherein the portion of the interconnected polymeric filaments is integrally bonded to a polymeric film.

Clause 137. The cushion of any of the preceding or subsequent clauses, wherein the interconnected polymeric filaments and the polymeric film are made of the same polymeric material.

Clause 138. The cushion of any of the preceding or subsequent clauses, wherein the film forms a skin along the mesh body.

Clause 139. The cushion of any of the preceding or subsequent clauses, wherein the mesh body is non-woven.

Clause 140. The cushion of any of the preceding or subsequent clauses, wherein the mesh body includes a base portion and an additional bolster portion.

Clause 141. The cushion of any of the preceding or subsequent clauses, wherein the first subset forms the base portion, and the second subset forms the additional bolster portion.

Clause 142. The cushion of any of the preceding or subsequent clauses, wherein the base portion defines a first profile, and an additional portion defines a second profile that is different than the first profile.

Clause 143. The cushion of any of the preceding or subsequent clauses, wherein the additional bolster portion includes a first bolster.

Clause 144. The cushion of any of the preceding or subsequent clauses, wherein the first bolster is attached the base portion at a first edge of the base portion.

Clause 145. The cushion of any of the preceding or subsequent clauses, wherein the first bolster comprises the second subset of polymeric filaments.

Clause 146. The cushion of any of the preceding or subsequent clauses, wherein the first subset of polymeric filaments comprises a first polymeric material and the second subset of polymeric filaments comprises a second polymeric material that is different than the first polymeric material (e.g., different composition, shape, size).

Clause 147. The cushion of any of the preceding or subsequent clauses, wherein the additional bolster portion comprises a second bolster.

Clause 148. The cushion of any of the preceding or subsequent clauses, wherein the second bolster is attached to the base portion at a second edge of the base portion.

Clause 149. The cushion of any of the preceding or subsequent clauses, wherein the second bolster is opposite the first bolster.

Clause 150. The cushion of any of the preceding or subsequent clauses, wherein the second bolster comprises a third subset of polymeric filaments of the plurality of interconnected polymeric filaments and the third subset of polymeric filaments is different (e.g., a different composition, shape, size) than the first and/or second subset of polymeric filaments.

Clause 151. The cushion of any of the preceding or subsequent clauses, wherein the third subset of polymeric filament comprises a third polymeric material that is different than the first polymeric material and/or second polymeric material.

Clause 152. The cushion of any of the preceding or subsequent clauses, wherein the additional bolster portion comprises a third bolster.

Clause 153. The cushion of any of the preceding or subsequent clauses, wherein the third bolster is attached to the base portion at a third edge of the base portion.

Clause 154. The cushion of any of the preceding or subsequent clauses, wherein a third edge is a rear edge of the base portion.

Clause 155. The cushion of any of the preceding or subsequent clauses, wherein the third bolster comprises a fourth subset of polymeric filaments that is different than the first, second, and/or third subset of polymeric filaments.

Clause 156. The cushion of any of the preceding or subsequent clauses, wherein the fourth subset of polymeric filaments comprises a fourth polymeric material that is different than the first, second, and/or third polymeric material.

Clause 157. The cushion of any of the preceding or subsequent clauses, wherein the additional bolster portion comprises a fourth bolster.

Clause 158. The cushion of any of the preceding or subsequent clauses, wherein the fourth bolster is attached to the base portion at a fourth edge.

Clause 159. The cushion of any of the preceding or subsequent clauses, wherein the fourth bolster is opposite the third bolster.

Clause 160. The cushion of any of the preceding or subsequent clauses, wherein the fourth edge is a front edge of the base portion.

Clause 161. The cushion of any of the preceding or subsequent clauses, wherein the fourth bolster comprises a fifth subset of polymeric filaments that is different than the first, second, third, and/or fourth subset of polymeric filaments.

Clause 162. The cushion of any of the preceding or subsequent clauses, wherein the fifth subset of polymeric filaments comprises a fifth polymeric material that is different than the first, second, third, and/or fourth polymeric material.

Clause 163. The cushion of any of the preceding or subsequent clauses, wherein the plurality of interconnected polymeric filaments includes a thermoplastic polymer.

Clause 164. The cushion of any of the preceding or subsequent clauses, wherein the density is a bulk density.

Clause 165. The cushion of any of the preceding or subsequent clauses, wherein the first hardness is no more than 5 kPa.

Clause 166. The cushion of any of the preceding or subsequent clauses, wherein the first hardness is less than the second hardness.

Clause 167. The cushion of any of the preceding or subsequent clauses, wherein the second hardness is at least 5 kPa.

Clause 168. The cushion of any of the preceding or subsequent clauses, wherein the plurality of interconnected polymeric filaments comprises a third subset of polymeric filaments that is different than the first subset of polymeric filaments and different than the second subset of polymeric filaments.

Clause 169. The cushion of any of the preceding or subsequent clauses, wherein the third subset has a hardness that is different than the first and second subsets.

Clause 170. The cushion of any of the preceding or subsequent clauses, wherein the second subset is disposed between the first and third subsets.

Clause 171. The cushion of any of the preceding or subsequent clauses, wherein the first subset has a first hardness and the second subset has a second hardness such that the first hardness is less than the second hardness and the third hardness is greater than the second hardness.

Clause 172. The cushion of any of the preceding or subsequent clauses, wherein the plurality of interconnected polymeric filament has a hardness gradient from a first region to a second region.

Clause 173. The cushion of any of the preceding or subsequent clauses, wherein the polymeric film is arranged such that it forms an exterior surface (e.g., skin) of the mesh body.

Clause 174. The cushion of any of the preceding or subsequent clauses, wherein the polymeric film is impermeable (e.g., to air or liquid).

Clause 175. The cushion of any of the preceding or subsequent clauses, wherein the polymeric film is arranged between a first subset of polymeric filaments and a second subset of polymeric filaments.

Clause 176. The cushion of any of the preceding or subsequent clauses, wherein the polymeric film defines an aperture.

Clause 177. The cushion of any of the preceding or subsequent clauses, wherein the plurality of interconnected polymeric filaments comprises a plurality of fused connections in which at least two filaments are bonded to each other.

Clause 178. The cushion of any of the preceding or subsequent clauses, wherein at least a portion of the polymeric filaments are not parallel or aligned.

Clause 179. The cushion of any of the preceding or subsequent clauses, wherein polymeric filaments in the plurality of interconnected polymeric filaments are randomly oriented.

Clause 180. The cushion of any of the preceding or subsequent clauses, wherein the plurality of interconnected polymeric filaments comprises a polymer selected from the group consisting of a polyolefin, a polyethylene, a polystyrene, a polyester, a polyurethane, and a polyamide.

Clause 181. The cushion of any of the preceding or subsequent clauses, wherein the polyethylene is a low-density polyethylene.

Clause 182. The cushion of any of the preceding or subsequent clauses, wherein the polyethylene is linear.

Clause 183. The cushion of any of the preceding or subsequent clauses, wherein the plurality of interconnected polymeric filaments includes an additional polyethylene that is different than a first polyethylene.

Clause 184. The cushion of any of the preceding or subsequent clauses, wherein the cushion is a seat cushion.

Clause 185. A seat assembly comprising a frame supporting the cushion of any of the preceding or subsequent clauses.

Clause 186. The seat assembly of any of the preceding or subsequent clauses, wherein the seat assembly is a vehicular seat assembly.

Clause 187. The seat assembly of any of the preceding or subsequent clauses, further comprising a seat trim, an actuator, and/or a heat transfer layer attached to the polymeric film.

Clause 188. A vehicle comprising a floorboard and the seat assembly of any of the preceding or subsequent clauses mounted to the floorboard.

Clause 189. A die tool (e.g., die/breaker plate and/or funnel) comprising a solid body (e.g., metal body) defining a first section (e.g., section for forming central seat cushion portion) defining a first plurality of orifices (e.g., nozzles/first subset of holes) such that it defines a first open space (e.g., collective open area of holes) and a first closed portion and a second section (e.g., section for forming bolsters) defining one or more orifices (e.g., nozzles/second subset of holes) such that it defines a second open space (e.g., collective open area of holes) and a second closed portion wherein (i) the first open space and the first closed portion is different (i.e., different orifice density/shape/size/different perimeter) than the second open space and the second closed portion, (ii) the orifices define a shape of a final product having a first profile and a second profile that is different than the first profile, (iii) the one or more orifices includes an elongated orifices to define a polymeric film, and/or (iv) the first plurality of orifices (e.g., first subset) is different (e.g., in density, shape, size, quantity, etc.) than the one or more orifices (e.g., second subset).

Clause 190. The die tool of any of the preceding or subsequent clauses, wherein the first section (e.g., forming central cushion portion) has a different orifice density (e.g., orifice per unit area) than the second section (e.g., bolsters).

Clause 191. The die tool of any of the preceding or subsequent clauses, wherein the first plurality of orifices (e.g., first subset) is a different size (e.g., average diameter) than the one or more orifices (e.g., second subset).

Clause 192. The die tool of any of the preceding or subsequent clauses, wherein the first plurality of orifices (e.g., first subset) of the first section has a different average diameter than the one or more orifices (e.g., second subset) of the second section.

Clause 193. The die tool of any of the preceding or subsequent clauses, wherein the one or more orifices (e.g., second subset) forms at least one slit (e.g., hole that forms polymeric film) through the solid body (e.g., metal body).

Clause 194. The die tool of any of the preceding or subsequent clauses, wherein the orifices of the die tool are arranged to dispense molten thermoplastic resin.

Clause 195. The die tool of any of the preceding or subsequent clauses, wherein the one or more orifices are arranged to define the outer perimeter of a cushion having a first and second bolster.

Clause 196. The die tool of any of the preceding or subsequent clauses, wherein the one or more orifices is a second plurality of orifices.

Clause 197. The die tool of any of the preceding or subsequent clauses, wherein the first section defines a first area, the first open space defines a first open area, the second section defines a second area, and the second open space defines a second open area wherein the first open area to the first area defines a ratio that is greater than the second open area to the second area.

Clause 198. The die tool of any of the preceding or subsequent clauses, wherein the one or more orifices includes a through aperture sized to match an overall perimeter of a cushion (e.g., to provide skin along exterior edge).

Clause 199. The die tool of any of the preceding or subsequent clauses, wherein the through aperture is configured to receive a molten thermoplastic resin and dispense it as a plurality of molten filaments.

Clause 200. The die tool of any of the preceding or subsequent clauses, wherein the through aperture is configured to maintain the plurality of molten filaments collectively in a final shape of a final product.

Clause 201. The die tool of any of the preceding or subsequent clauses, wherein the first orifice density is no more than 8 orifice per square inch.

Clause 202. The die tool of any of the preceding or subsequent clauses, wherein the second orifice density is at least 9 orifice per square inch.

Clause 203. The die tool of any of the preceding or subsequent clauses, wherein the first and second average diameters are different by at least 0.4 mm.

Clause 204. The die tool of any of the preceding or subsequent clauses, wherein there are more orifices in the first section per unit area than orifices in the second section per unit area.

Clause 205. The die tool of any of the preceding or subsequent clauses, further comprising a template configured to cover at least a portion of the plurality of orifices and/or one or more orifices (e.g., which may overlay/cover a portion of a die to define the cross-sectional shape of a final product).

Clause 206. The die tool of any of the preceding or subsequent clauses, wherein the template has a predefined outline portion defining a cross section of a portion of a vehicle interior component.

Clause 207. The die tool of any of the preceding or subsequent clauses, wherein the template has a predefined outline portion defining a cross section of a portion of a cushion.

Clause 208. The die tool of any of the preceding or subsequent clauses, wherein the first section is positioned in a location that corresponds to respective bolster portions of the seat cushion.

Clause 209. The die tool of any of the preceding or subsequent clauses, wherein the through aperture is shaped as a seat cushion.

Clause 210. The die tool of any of the preceding or subsequent clauses, wherein the through aperture is configured to form a unitary non-woven cushion.

Clause 211. The die tool of any of the preceding or subsequent clauses, wherein the through aperture is shaped with curvature to form a unitary non-woven cushion with curvature.

Clause 212. The die tool of any of the preceding or subsequent clauses, wherein the through aperture is provided with a plurality of curvatures of at least 12 mm radii.

Clause 213. The die tool of any of the preceding or subsequent clauses, wherein the through aperture is formed with a convex perimeter to form a concave surface of a cushion.

Clause 214. A dispensing system comprising a dispenser (e.g., extruder) with the die tool of any of the preceding or subsequent clauses disposed thereon such that during operation the dispenser dispenses a molten thermoplastic resin through the orifices of the die tool.

Clause 215. The dispensing system of any of the preceding or subsequent clauses, wherein the dispenser is an extruder to extrude the molten thermoplastic resin through the orifices of the die tool to form molten thermoplastic filaments.

Clause 216. The dispensing system of any of the preceding or subsequent clauses, further comprising a fluid chamber (e.g., cooling bath) to receive the molten thermoplastic filaments and resist a flow of the molten thermoplastic filaments which buckles the filaments such that they intersect and/or bond together to form a unitary non-woven body in a shape of the overall perimeter of the cushion.

Clause 217. The dispensing system of any of the preceding or subsequent clauses, wherein the die tool is aligned with the fluid chamber to cool the molten thermoplastic filaments as a unitary non-woven cushion.

Clause 218. The dispensing system of any of the preceding or subsequent clauses, wherein the die tool defines cooling passage formed through the die tool to cool the molten thermoplastic filaments as a unitary non-woven cushion.

Clause 219. A vehicle interior component comprising a plurality of interconnected polymeric filaments dispensed through the die tool of any of the preceding or subsequent clauses.

Clause 220. A cushion comprising a plurality of interconnected polymeric filaments dispensed through the die tool of any of the preceding or subsequent clauses.

Clause 221. A method such as for producing a vehicular seat cushion comprising dispensing (e.g., extruding) a molten polymeric resin through a die assembly (e.g., die plate, template, and/or funnel) having a first region defining a first plurality of apertures (e.g., first subset) to dispense molten polymeric filaments and a second region defining one or more additional apertures (e.g., second subset) to dispense additional molten polymeric member (e.g., additional filaments and/or a film) that is different than the molten polymeric filaments, wherein the first region defines a first ratio of a first blocked area (e.g., solid portion of die plate) to a first open area (e.g., collective area of holes) that is different than a second ratio of a second blocked area to a second open area of the second region, and cooling the molten polymeric filaments and the additional molten polymeric member to form a (e.g., nonwoven) mesh body including interconnected polymeric filaments and having a first portion different from a second portion.

Clause 222. The method of any of the preceding or subsequent clauses, wherein the mesh body is a non-foam cushion.

Clause 223. The method of any of the preceding or subsequent clauses, wherein the mesh body is an interior vehicle component.

Clause 224. The method of any of the preceding or subsequent clauses, wherein the additional molten polymeric member is additional polymeric filaments having a different shape, size, density, and/or composition.

Clause 225. The method of any of the preceding or subsequent clauses, wherein the molten polymeric material is extruded through the die assembly.

Clause 226. The method of any of the preceding or subsequent clauses, wherein the first plurality of apertures or one or more additional apertures defines a perimeter in the shape of a final product (e.g., vehicular seat cushion).

Clause 227. The method of any of the preceding or subsequent clauses, wherein the final product is a seat cushion.

Clause 228. The method of any of the preceding or subsequent clauses, wherein the final product is an interior vehicle component.

Clause 229. The method of any of the preceding or subsequent clauses, wherein the first plurality of apertures (e.g., first subset of holes) defines a first profile that is different than a second profile defined by the one or more additional apertures (e.g., second subset of holes).

Clause 230. The method of any of the preceding or subsequent clauses, wherein additional molten polymeric member is a polymeric film.

Clause 231. The method of any of the preceding or subsequent clauses, wherein the polymeric film is connected to the interconnected polymeric filaments.

Clause 232. The method of any of the preceding or subsequent clauses, wherein the polymeric film is bonded to the interconnected polymeric filaments.

Clause 233. The method of any of the preceding or subsequent clauses, wherein the molten polymeric filaments are dispensed into a medium interface (e.g., air/water interface) defined by a first medium (e.g., air) and a second medium (e.g., water) such that at least a subset of the molten polymeric filaments is deflected and/or buckled (e.g., changes directions) such that it intersects, intertwines, entangles, and/or bonds while hardening such as from cooling water to form the (e.g., nonwoven) mesh body in the second medium (e.g., water).

Clause 234. The method of any of the preceding or subsequent clauses, further comprising removing the (e.g., nonwoven) mesh body from the second medium (e.g., water) and drying the (e.g., nonwoven) mesh body.

Clause 235. The method of any of the preceding or subsequent clauses, wherein the first medium is a gas (e.g., air) and the second medium is a liquid (e.g., water).

Clause 236. The method of any of the preceding or subsequent clauses, wherein the first medium is air, and the second medium is water.

Clause 237. The method of any of the preceding or subsequent clauses, wherein the plurality of apertures (e.g., first subset) is arranged at a first aperture density and the one or more additional apertures (e.g., second subset) is arranged at a second aperture density that is different than the first aperture density.

Clause 238. The method of any of the preceding or subsequent clauses, wherein the plurality of apertures defines a first average diameter, and the one or more additional apertures defines a second average diameter that is different than the first average diameter.

Clause 239. The method of any of the preceding or subsequent clauses, wherein the first portion of the (e.g., nonwoven) mesh body has a first hardness and the second portion of the (e.g., nonwoven) mesh body has a second hardness that is different than the first hardness.

Clause 240. The method of any of the preceding or subsequent clauses, wherein a first thermoplastic polymer is dispensed through the orifice of the first region such that the first portion is a plastic mesh base of interconnected polymeric filaments and a second thermoplastic polymer is dispensed through the one or more orifice of the second region such that the second portion is a first plastic mesh bolster of interconnected polymeric filaments attached to the plastic mesh base, the second thermoplastic polymer being different than the first thermoplastic polymer.

Clause 241. The method of any of the preceding or subsequent clauses, further comprising dispensing (e.g., extruding) the first thermoplastic polymer, the second thermoplastic polymer, or a third thermoplastic polymer (e.g., different than first and/or second material) through a third region of the die assembly such that a third portion of the mesh body is a second plastic mesh bolster.

Clause 242. The method of any of the preceding or subsequent clauses, wherein the plastic mesh base comprises a first side edge, a second side edge, a front edge, a rear edge, a first face, and a second face and the first plastic mesh bolster is attached to the plastic mesh base at the first edge.

Clause 243. The method of any of the preceding or subsequent clauses, wherein the second plastic mesh bolster is attached to the plastic mesh base at the second edge.

Clause 244. The method of any of the preceding or subsequent clauses, wherein the first plurality of apertures (e.g., first subset) of the first region of die plate defines a first open space per unit area and the one or more additional apertures of the second region defines a second open space per unit area in the second region such that the first open space per unit area is greater than the second open space per unit area.

Clause 245. The method of any of the preceding or subsequent clauses, further comprising heating a polymeric material to a molten state such that when it is received by the die assembly and dispensed through the die assembly it forms the molten polymeric filaments and/or the additional molten polymeric member.

Clause 246. The method of any of the preceding or subsequent clauses, further comprising surrounding the molten polymeric filaments with a heating arrangement operable to apply heat to the molten polymeric filaments.

Clause 247. The method of any of the preceding or subsequent clauses, further comprising introducing the molten polymeric filament and/or the additional molten polymeric member into a cooling bath to form the mesh body of interconnected polymer filament.

Clause 248. The method of any of the preceding or subsequent clauses, wherein the second medium (e.g., water) is disposed in the cooling (e.g., water) bath.

Clause 249. The method of any of the preceding or subsequent clauses, wherein the die assembly includes a die plate.

Clause 250. The method of any of the preceding or subsequent clauses, wherein the die assembly includes template.

Clause 251. The method of any of the preceding or subsequent clauses, wherein cooling occurs after the molten polymeric filament leaves the die plate.

Clause 252. The method of any of the preceding or subsequent clauses, wherein the one or more additional apertures includes an aperture sized to match an overall perimeter of a product and the die assembly maintains the molten polymeric filaments within the overall perimeter of the product.

Clause 253. The method of any of the preceding or subsequent clauses, wherein there are more apertures per unit area in the first region than apertures per unit area in the second region.

Clause 254. The method of any of the preceding or subsequent clauses, wherein the first plurality of apertures comprises a larger diameter than the one or more additional apertures.

Clause 255. The method of any of the preceding or subsequent clauses, further comprising masking (e.g., covering) a portion of die plate with a template comprising a predefined outline such that the (nonwoven) mesh body has a cross-section that is defined by the predefined outline.

Clause 256. The method of any of the preceding or subsequent clauses, wherein the second region includes a location that corresponds to a location of an occupant sensor in the mesh body.

Clause 257. The method of any of the preceding or subsequent clauses, wherein the second region corresponds to respective bolster areas of a cushion.

Clause 258. The method of any of the preceding or subsequent clauses, wherein the die assembly comprises a third region defining a second plurality of apertures, the third region defining a third ratio of a third blocked area to a third open area that is different than the first and/or second ratio.

Clause 259. The method of any of the preceding or subsequent clauses, wherein the third open area per unit area is less than the first and/or second area per unit area.

Clause 260. The method of any of the preceding or subsequent clauses, further comprising heating an entire perimeter of the molten polymeric filaments.

Clause 261. The method of any of the preceding or subsequent clauses, further comprising replacing the die assembly (interchangeability) or a portion thereof with a second die assembly or portion thereof.

Clause 262. The method of any of the preceding or subsequent clauses, wherein the die assembly or a portion thereof includes an interchangeable die plate or template.

Clause 263. The method of any of the preceding or subsequent clauses, wherein the plurality of apertures forms a size or distribution gradient along the die assembly such that the mesh body comprises a hardness gradient.

Clause 264. The method of any of the preceding or subsequent clauses, wherein the third region of the die assembly is configured to provide a third portion of the mesh body having a third hardness that is greater than a second hardness of the second portion of the mesh body which is greater than a first hardness of the first portion of the (e.g., nonwoven) mesh body.

Clause 265. The method of any of the preceding or subsequent clauses, wherein the second portion is disposed between the first and third portions.

Clause 266. The method of any of the preceding or subsequent clauses, wherein the third portion has a hardness that is different than the second hardness and within 10% of the first hardness.

Clause 267. The method of any of the preceding or subsequent clauses, wherein the additional molten polymeric member (e.g., film) is dispensed on an exterior surface of the mesh body.

Clause 268. The method of any of the preceding or subsequent clauses, further comprising dispensing the film on an exterior surface of the mesh body.

Clause 269. The method of any of the preceding or subsequent clauses, wherein the additional molten polymeric member (e.g., film) is dispensed between at least two subsets of the interconnected polymeric filaments.

Clause 270. The method of any of the preceding or subsequent clauses, further comprising dispensing the film between at least two subsets of the interconnected polymeric filaments.

Clause 271. The method of any of the preceding or subsequent clauses, further comprising forming an aperture through the film.

Clause 272. The method of any of the preceding or subsequent clauses, wherein the one or more additional apertures (e.g., second subset) comprises a slit to dispense a film as the additional polymeric member.

Clause 273. The method of any of the preceding or subsequent clauses, further comprising removing the dispensing assembly or a portion thereof and installing a second dispensing assembly or portion thereof.

Clause 274. The method of any of the preceding or subsequent clauses, further comprising dispensing a different mesh body through the second dispensing assembly or portion thereof.

Clause 275. The method of any of the preceding or subsequent clauses, further comprising assembling a seat with the (e.g., nonwoven) mesh body.

Clause 276. The method of any of the preceding or subsequent clauses, wherein the film is an impermeable film.

Clause 277. The method of any of the preceding or subsequent clauses, further comprising attaching at least one of a seat trim, an actuator, and/or a heat transfer layer to the film.

Clause 278. The method of any of the preceding or subsequent clauses, wherein the heating arrangement comprises a rectangular heating structure to surround the molten polymeric filaments as the molten polymeric filaments leave the die assembly.

Clause 279. The method of any of the preceding or subsequent clauses, wherein a heating arrangement is attached to a side of the die assembly.

Clause 280. The method of any of the preceding or subsequent clauses, wherein a heating arrangement is attached to each side of the die assembly.

Clause 281. The method of any of the preceding or subsequent clauses, wherein a die assembly is rectangular.

Clause 282. The method of any of the preceding or subsequent clauses, wherein the heating arrangement controls an air temperature around the molten polymeric filaments to a temperature of 60 to 140° C.

Clause 283. The method of any of the preceding or subsequent clauses, wherein the heating arrangement is positioned at least 100 to 150 mm from the molten polymeric filaments.

Clause 284. The method of any of the preceding or subsequent clauses, wherein the molten polymeric filaments include an outer portion disposed toward an outside edge of the die assembly, and an inner portion disposed inward from the outer portion, and a heating arrangement configured to heat the outer portion such that bonding between the molten polymeric filaments of the outer portion is greater than bonding between the molten polymeric filaments of the inner portion.

Clause 285. The method of any of the preceding or subsequent clauses, wherein a first polymeric material is dispensed through the first region of the die assembly and a second polymeric material is dispensed through the second region of the die assembly, the second polymeric material (e.g., polyethylene) being different than the first polymeric material (e.g., polypropylene, polystyrene, polycarbonate, and/or polyvinyl chloride).

Clause 286. The method of any of the preceding or subsequent clauses, wherein second polymeric material is introduced into the die assembly toward an outside edge of the die assembly and the first polymeric material is introduced into the die assembly inward from the second polymeric material such that the additional molten polymeric member at least partially surrounds the first polymeric filaments.

Clause 287. The method of any of the preceding or subsequent clauses, further comprising dispensing a third polymeric material through the die assembly that is different than the first and/or second polymeric materials.

Clause 288. The method of any of the preceding or subsequent clauses, wherein the third polymeric material is different than the first and second polymeric material and the first and second polymeric materials are different from each other.

Clause 289. The method of any of the preceding or subsequent clauses, wherein the first plurality of apertures collectively has a greater area than the one or more additional apertures.

Clause 290. The method of any of the preceding or subsequent clauses, wherein the first plurality of apertures forms a plurality of nozzles, and the method further comprises closing a plurality of nozzles or a subset thereof outside the one or more additional apertures.

Clause 291. The method of any of the preceding or subsequent clauses, further comprising cooling the die assembly.

Clause 292. The method of any of the preceding or subsequent clauses, further comprising providing a mold with the one or more additional apertures as the die assembly.

Clause 293. The method of any of the preceding or subsequent clauses, wherein the mold comprises cooling passage therethrough to cool the mesh body.

Clause 294. The method of any of the preceding or subsequent clauses, further comprising placing the mold in a cooling fluid such that the cooling fluid cools the mesh body.

Clause 295. The method of any of the preceding or subsequent clauses, wherein the mesh body further comprises a concave contoured perimeter.

Clause 296. A product such as a vehicular seat cushion is formed by the method of any of the preceding or subsequent clauses.

Clause 297. A vehicle interior component formed by the method of any of the preceding or subsequent clauses.

Clause 298. A system such as for producing a vehicular non-foam seat cushion comprising a shaping assembly (e.g., die, template, funnel) comprising a die plate, the die plate having a first region with a plurality of apertures and a second region with one or more additional apertures that are different than the plurality of apertures, and an extruder to extrude one or more polymeric materials through the shaping assembly to form a mesh cushion body.

Clause 299. The system of any of the preceding or subsequent clauses, further comprising a template to block a portion of the apertures, a funnel to direct molten polymeric filaments extruded through the die plate into a unitary body and/or a cooling bath, a heating arrangement to heat the molten polymeric filaments, and/or conveyor assembly to convey the unitary body through the cooling bath.

Clause 300. The system of any of the preceding or subsequent clauses, wherein (i) the first region of the die plate defines a first closed portion and a first open space, and the second region defines a second closed portion and a second open space such that the first closed portion is different than the second closed portion and/or the first open space is different than the second open space, (ii) the first region defines a perimeter in the shape of a final product, (iii) the one or more additional apertures comprises a slit for dispensing a polymeric film, (iv) a first aperture density of the first region is different than a second aperture density of the second region, and/or (v) the size of the plurality of apertures is different than the size of the one or more additional apertures.

Clause 301. The system of any of the preceding clauses, wherein the first region defines a first profile and the second region defines a second profile that is different than the first profile.

1.-301. (canceled)

302. A method for producing a vehicle interior component, comprising:
heating a polymeric material to a molten state, such that it becomes a molten polymer;
introducing the molten polymer into a die plate having a first area containing a plurality of first holes therethrough and a second area containing a plurality of second holes therethrough, the first holes together defining a first open space per unit area in the first area and the second holes together defining a second open space per unit area in the second area, and wherein the first open space per unit area is greater than the second open space per unit area, the first and second plurality of holes being arranged in a shape of a mesh body; and
cooling the molten polymer after it leaves the die plate.

303. The method of claim 302, wherein there are more of the first holes per unit area in the first area than the second holes per unit area in the second area.

304. The method of claim 302, wherein the first holes have a larger diameter than the second holes.

305. The method of claim 302, wherein cooling the polymer after it leaves the die plate produces the mesh body, the method further comprising masking a portion of the die plate with a template having a predefined outline portion such that the mesh body has a cross section that is defined by the predefined outline portion.

306. The method of claim 305, wherein the second area includes a location that corresponds to a location of an occupant sensor in the mesh body.

307. The method of claim 306, wherein the die plate includes two of the first areas, each being positioned in a location that corresponds to a respective bolster area of the mesh body.

308. The method of claim 307, wherein the die plate includes a third area containing a plurality of third holes therethrough, the third holes together defining a third open space per unit area in the third area, and wherein the third open space per unit area is less than the second open space per unit area.

309. A vehicle interior component formed by the method of claim 302.

310. A method for producing a vehicle interior component, comprising:
heating a polymeric material to a molten state, such that it becomes a molten polymer;
introducing the molten polymer into a die plate including a first area having an open portion and a closed portion and a second area having an open portion and a closed portion, and wherein a ratio of the open portion of the first area to the first area is greater than a ratio of the open portion of the second area to the second area, the open portions are arranged to form a mesh body when cooled; and
cooling the molten polymer after it leaves the die plate to form the mesh body.

311. The method of claim 310, wherein the first area includes a plurality of first holes defining the open portion of the first area, and the second area includes a plurality of second holes defining the open portion of the second area, and wherein there are more of the first holes per unit area in the first area than the second holes per unit area in the second area.

312. The method of claim 310, wherein the first area includes a plurality of first holes defining the open portion of the first area, and the second area includes a plurality of second holes defining the open portion of the second area, and wherein the first holes have a larger diameter than the second holes.

313. The method of claim 310, wherein the mesh body has a cross section and the method further comprises masking a portion of the die plate with a template having an outline defining the cross section of the mesh body.

314. The method of claim 313, wherein the die plate includes a plurality of the first areas, each being positioned in a location that corresponds to a respective bolster area of the cushion blank.

315. The method of claim 313, wherein the second area includes a location configured to receive an occupant sensor in the mesh body.

316. The method of claim 310, wherein the die plate further includes a third area having an open portion and a closed portion, and wherein the ratio of the open portion of the second area to the second area is greater than a ratio of the open portion of the third area to the third area.
